(19) United States
(12) Patent Application Publication
(10) Pub. No.: US 2026/0156636 A1
(43) Pub. Date: Jun. 4, 2026

(54) SCHEDULING AVAILABILITY FOR USER EQUIPMENT SUPPORTING MULTI-RECEIVER SIMULTANEOUS RECEPTION

(71) Applicant: Intel Corporation, Santa Clara, CA (US)

(72) Inventors: MENG ZHANG, Beijing (CN); RICHARD BURBIDGE, Shrivenham (GB); ANDREY CHERVYAKOV, Maynooth (IE); HUA LI, Beijing (CN); RUI HUANG, Beijing (CN); IN-SEOK HWANG, Santa Clara, CA (US)

(73) Assignee: Intel Corporation, Santa Clara, CA (US)

(21) Appl. No.: 19/118,999

(22) PCT Filed: Nov. 6, 2023
(86) PCT No.: PCT/US23/78834

§ 371 Date: Apr. 7, 2025

Related U.S. Application Data
(60) Provisional application No. 63/423,407, filed on Nov. 7, 2022.
(60) Provisional application No. 63/423,752, filed on Nov. 8, 2022.

(51) Int. Cl. H04W 72/12

(52) U.S. Cl. CPC H04W 72/12

(57) ABSTRACT

Embodiments attempt to solve challenges in a wireless communications system. Embodiments describe various techniques, systems, and devices to support simultaneous reception information and scheduling restriction information for user equipment in a 3GPP 5G NR or 6G system, among other wireless communications systems. Other embodiments are described and claimed.

This application claims the benefit of and priority to previously filed U.S. Provisional Patent Application Ser. No. 63/423,407, filed Nov. 7, 2022, entitled “RADIO RESOURCE MANAGEMENT (RRM) IMPACTS FOR LAYER 1 (L1)-REFERENCE SIGNAL RECEIVED POWER (RSRP) MEASUREMENT BASED ON FREQUENCY RANGE 2 (FR2) MULTI-RECEIVER (MULTI-RX) CHAIN”, and U.S. Provisional Patent Application Ser. No. 63/423,752, filed Nov. 8, 2022, entitled “APPLICABLE SCENARIO AND UE CAPABILITY FOR SIMULTANEOUS RECEPTION WITH FR2 MULTI-RX,” both of which are hereby incorporated by reference in their entireties.

### BACKGROUND

Wireless communication systems are rapidly growing in usage. Further, wireless communication technology has evolved from voice-only communications to also include the transmission of data, such as Internet and multimedia content, to a variety of devices. To accommodate a growing number of devices communicating, many wireless communication systems share the available communication channel resources among devices. Further, Internet-of-Thing (IoT) devices are also growing in usage and can coexist with user devices in various wireless communication systems such as cellular networks.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a wireless communication system in accordance with one embodiment.

FIG. 2 illustrates a wireless communication system in accordance with one embodiment.

FIG. 3A illustrates an operating environment in accordance with one embodiment.

FIG. 3B illustrates an operating environment in accordance with one embodiment.

FIG. 3C illustrates an operating environment in accordance with one embodiment.

FIG. 3D illustrates an operating environment in accordance with one embodiment.

FIG. 4 illustrates a user equipment (UE) in accordance with one embodiment.

FIG. 5 illustrates an operating environment in accordance with one embodiment.

FIG. 6A illustrates a data schema for UE capability information in accordance with one embodiment.

FIG. 6B illustrates a data schema for UE configuration information in accordance with one embodiment.

FIG. 7 illustrates an apparatus for a UE in accordance with one embodiment.

FIG. 8 illustrates an apparatus for a base station in accordance with one embodiment.

FIG. 9 illustrates a logic flow in accordance with one embodiment.

FIG. 10 illustrates a logic flow in accordance with one embodiment.

FIG. 11 illustrates a first network in accordance with one embodiment.

FIG. 12 illustrates a second network in accordance with one embodiment.

FIG. 13 illustrates a third network in accordance with one embodiment.

FIG. 14 illustrates a computer readable storage medium in accordance with one embodiment.

### DETAILED DESCRIPTION

Embodiments are generally directed to wireless communication systems. Some embodiments are particularly directed to improving simultaneous reception capabilities for base stations and/or user equipment (UE) in a wireless communications system. Some embodiments dynamically define a set of scheduling restrictions and/or measurement restrictions for simultaneous reception by a UE of signals from multiple transmission sources, such as intra-cell or inter-cell base stations, for example. More particularly, embodiments define UE capability and provide dynamic scheduling restrictions and measurement restrictions for those cases where a UE is equipped to support simultaneous reception under normal operating conditions but is unable to sustain simultaneous reception due to one or more technical factors, such as UE movement, a UE geospatial position, a UE angle, a UE radio failure, UE interference, UE transmission environment, transmission obstacles, and so forth. Embodiments are not limited to these examples.

In one embodiment, for example, the term “simultaneous reception” may refer to a UE receiving two or more signals in a same or overlapping orthogonal frequency division multiplexed (OFDM) symbols from one or more transmission sources. For instance, the overlapping signals may comprise various combinations of a data signal and a reference signal. In this case, simultaneous reception may refer to a UE receiving multiple data signals, multiple reference signals, or a combination of data signals and reference signals. Embodiments are not limited to these types of signals or signal permutations.

In one embodiment, for example, the term “scheduling restriction” may refer to a set of defined conditions that should be, or must be, implemented by a UE during simultaneous reception operations by the UE. A network scheduler may determine one or more scheduling restrictions for a UE based on a number of factors, such as UE capabilities, overall network operations, or available network resources at a given moment in time. For example, a scheduling restriction may limit or restrict the UE from performing certain operations during simultaneous reception operations by the UE, such as receiving signals from certain transmission sources (e.g., base stations), measuring certain signals or frequency ranges, performing radio link monitoring, and so forth. Stated another way, a scheduling restriction may define availability of the UE to perform certain operations during simultaneous reception operations by the UE. Examples of a scheduling restriction may comprise scheduling availability of a UE during radio link monitoring on frequency range 1 (FR1) or frequency range 2 (FR2), scheduling availability of a UE performing beam failure detection on FRI or FR2, scheduling availability of a UE performing transmission and reception point (TRP) specific beam failure detection on FR1 or FR2, and so forth. Embodiments are not limited to these examples or a given set of conditions defined for a UE, and the conditions may vary based on different implementations.

In general, a wireless communications system may implement improvements to requirements for support of Radio Resource Management (RRM) for Frequency Division Duplex (FDD) and Time Division Duplex (TDD) modes of New Radio (NR). These requirements include, for example, requirements on measurements in NR and the UE as well as requirements on node dynamical behavior and interaction, in terms of delay and response characteristics, among other RRM requirements. Embodiments support improved network services, such as handover, load balancing, and overall network utilization and performance.

In many wireless communication systems, including long-term evolution (LTE) and fifth generation (5G) new radio (5G NR) and sixth generation (6G) cellular networks, a UE transmits data to a base station (BS) over a radio using various radio resources. As such, RRM is a crucial component of a radio access network (RAN), such as RAN in Third Generation Partnership Project (3GPP) systems, including LTE, 5G NR and 6G cellular networks. RRM manages the allocation and coordination of the radio resources, including frequency, power, and time slots, among different users and services in the network. The primary goal of RRM is to ensure efficient and reliable use of radio resources while maintaining the quality of service (QoS) for all users. Some of the key functions of RRM in 3GPP systems include radio resource allocation, congestion control, handover management, scheduling, and power control. RRM also plays a critical role in managing interference and optimizing network capacity and coverage. Overall, RRM helps ensure the efficient and effective operation of wireless networks.

Various 3GPP documents define RRM for a 5G NR and 6G system, including 3GPP Technical Standards (TS), Technical Reports (TR), Change Request (CR), and/or Work Items (WI). Various embodiments discussed herein may be implemented in a wireless communications system as defined by the 3GPP TS 38.133 titled “Technical Specification Group Radio Access Network; NR; Requirements for support of radio resource management,” Release 17, Version 18.3.0 (September 2023), and including future versions, revisions or variants (collectively referred to as “3GPP TS 38.133 Standards”). In particular, embodiments may be implemented in a wireless communications system as defined by the 3GPP TS 38.133 Standards, including any change requests submitted in CR R4-2317431 to 3GPP TS 38.133 Standards titled “Draft Big CR to TS 38.133 for RRM requirements for NR FR2 multi-Rx chain DL reception” (October 2023). It may be appreciated that the embodiments may be implemented in accordance with other 3GPP TS, TR, CR and WI, as well as other wireless standards released by other standards entities. Embodiments are not limited in this context.

A UE typically comprise radio resources that include one or more radio antenna modules. In the context of a 3GPP radio antenna module, a panel refers to a specific component or element within the module that is responsible for transmitting and/or receiving wireless signals. The panel in a 3GPP radio antenna module is typically a physical structure that contains multiple antenna elements. These antenna elements are designed to operate within the frequency bands specified by the 3GPP standards. The panel is usually composed of multiple antenna elements arranged in an array formation, allowing for the transmission and reception of signals in specific directions. The use of multiple elements in an array allows for improved signal coverage, increased capacity, and enhanced performance by supporting features like beamforming and Multiple Input Multiple Output (MIMO) communication. The specific design and characteristics of the panel in a 3GPP radio antenna module may vary based on the particular implementation and requirements of the radio module itself, as well as the specific use case or deployment scenario.

In some instances, a UE may have sufficient radio resources to support simultaneous reception operations. Whether a UE may support simultaneous reception depends, in part, on a number of radio antenna modules and panels for each of the radio antenna modules implemented for the UE. For example, when the UE comprises multiple radio antenna modules and/or multiple panels per radio antenna module, the UE may use the multiple radio antenna modules and/or panels to support simultaneous reception operations.

Simultaneous reception, in the context of 3GPP, refers to the capability of a receiver to process and decode multiple incoming signals simultaneously. It allows a receiver to handle and demodulate multiple transmissions from different sources or on different frequency bands concurrently. The ability for simultaneous reception is especially significant in scenarios where multiple users or multiple services share the same radio resources. It enables efficient utilization of the available spectrum and improves network capacity and performance. In 3GPP standards, techniques like MIMO and beamforming are used to support simultaneous reception. MIMO allows multiple antennas at both the transmitter and receiver to transmit and receive multiple spatially separated streams, enhancing spectral efficiency and link reliability. Beamforming allows the focusing of transmission or reception towards specific directions, further improving signal quality and capacity. Simultaneous reception is a crucial feature in modern cellular systems like LTE, 5G and 6G systems, as it enables concurrent data transmission and reception, leading to higher data rates, reduced latency, and overall improved network performance.

In 3GPP Release 17, a UE is only equipped with a radio antenna module comprising a single panel. In this configuration, the UE can only receive signals in one direction. It cannot receive signals from two directions simultaneously, and it is therefore not capable of simultaneous reception.

In 3GPP Release 18, however, Radio Access Network Working Group 4 (RAN4) will define requirements for a UE that can support multiple radio antenna modules using multiple panels. With two or more panels, a UE can simultaneously receive signals from a single transmit and reception point (TRP), co-located TRPs, or intra-cell multi-TRP. It will enhance RRM requirements, such as scheduling restrictions and measurement restrictions, for example. Embodiments herein relate to the simultaneous reception scenario, as well as possible enhanced RRM requirements.

In some cases, however, even when a UE has multiple radio antenna modules and/or multiple panels, it may not necessarily be able to support simultaneous reception. For example, assume the UE comprises a mobile device capable of movement between different geographic positions. Further, a user may rotate the UE in three-dimensional (3D) space, changing an angle or orientation of the UE relative to signal sources, such as base stations or wireless access points (WAPs). As a result of these types of movements, a UE may not be able to receive two signals simultaneously. A user may manipulate the UE to place one or more of the multiple radio antenna modules and/or multiple panels in a position that makes them inaccessible to a signal envelope from a transmission source. For instance, a user may rotate the UE to place a radio antenna module against the ground or at an angle that blocks signal reception. Consequently, there is a need to define applicable scenarios for simultaneous reception based on a position of a UE at a given moment in time.

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

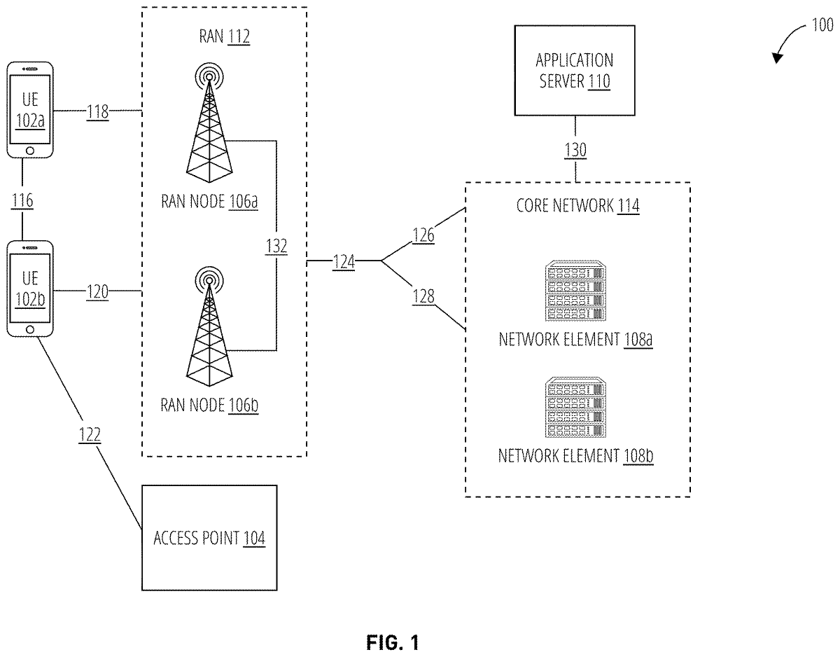

FIG. 1 illustrates an example of a wireless communication wireless communications system 100. For purposes of convenience and without limitation, the example wireless communications system 100 is described in the context of the long-term evolution (LTE) and fifth generation (5G) new radio (NR) (5G NR) cellular networks communication standards as defined by one or more 3GPP TS 38.133 Standards, 3GPP TS 38.304 Standards, 3GPP 38.331 Standards, or 3GPP 38.700 Standards, or other 3GPP standards or specifications. However, other types of wireless standards are possible as well.

The wireless communications system 100 supports two classes of UE devices, including a reduced capability (RedCap) UE 102a and standard UE 102b (collectively referred to as the “UEs 102”). In one embodiment, the UE 102a may have a set of one or more reduced capabilities relative to a set of standard capabilities of the standard UE 102b. Examples of reduced capabilities may include without limitation: (1) 20 megahertz (MHz) in sub-7 gigahertz (GHz) or 100 MHz in millimeter wave (mmWave) frequency bands; (2) a single transmit (Tx) antenna (1 Tx); (3) a single receive (Rx) antenna (1 Rx), with 2 antennas (2 Rx) being optional; (4) optional support for half-duplex FDD; (5) lower-order modulation, with 256-quadrature amplitude modulation (QAM) being optional; and (6) support for lower transmit power. In one embodiment, for example, the standard UE 102b may have a 2 Rx antenna, while the UE 102a may only have a 1 Rx antenna. The UE 102a may have other reduced capabilities as well. Embodiments are not limited in this context.

In this example, the UEs 102 are illustrated as smartphones (e.g., handheld touchscreen mobile computing devices connectable to one or more cellular networks). In other examples, any of the UEs 102 can include other mobile or non-mobile computing devices, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine-type communications (MTC) devices, machine-to-machine (M2M) devices, Internet of Things (IoT) devices, or combinations of them, among others.

In some implementations, any of the UEs 102 may be IoT UEs, which can include a network access layer designed for low-power IoT applications utilizing short-lived UE connections. An IoT UE can utilize technologies such as M2M or MTC for exchanging data with an MTC server or device using, for example, a public land mobile network (PLMN), proximity services (ProSe), device-to-device (D2D) communication, sensor networks, IoT networks, or combinations of them, among others. The M2M or MTC exchange of data may be a machine-initiated exchange of data. An IoT network describes interconnecting IoT UEs, which can include uniquely identifiable embedded computing devices (within the Internet infrastructure), with short-lived connections. The IoT UEs may execute background applications (e.g., keep-alive messages or status updates) to facilitate the connections of the IoT network.

The UEs 102 are configured to connect (e.g., communicatively couple) with a radio access network (RAN) 112. In some implementations, the RAN 112 may be a next generation RAN (NG RAN), an evolved UMTS terrestrial radio access network (E-UTRAN), or a legacy RAN, such as a UMTS terrestrial radio access network (UTRAN) or a GSM EDGE radio access network (GERAN). As used herein, the term “NG RAN” may refer to a RAN 112 that operates in a 5G NR wireless communications system 100, and the term “E-UTRAN” may refer to a RAN 112 that operates in an LTE or 4G wireless communications system 100.

To connect to the RAN 112, the UEs 102 utilize connections (or channels) 118 and 120, respectively, each of which can include a physical communications interface or layer, as described below. In this example, the connections 118 and 120 are illustrated as an air interface to enable communicative coupling, and can be consistent with cellular communications protocols, such as a global system for mobile communications (GSM) protocol, a code-division multiple access (CDMA) network protocol, a push-to-talk (PTT) protocol, a PTT over cellular (POC) protocol, a universal mobile telecommunications system (UMTS) protocol, a 3GPP LTE protocol, a 5G NR protocol, or combinations of them, among other communication protocols.

The UE 102b is shown to be configured to access an access point (AP) 104 (also referred to as “WLAN node 104,” “WLAN 104,” “WLAN Termination 104,” “WT 104” or the like) using a connection 122. The connection 122 can include a local wireless connection, such as a connection consistent with any IEEE 802.11 protocol, in which the AP 104 would include a wireless fidelity (Wi-Fi) router. In this example, the AP 104 is shown to be connected to the Internet without connecting to the core network of the wireless system, as described in further detail below.

The RAN 112 can include one or more nodes such as RAN nodes 106a and 106b (collectively referred to as “RAN nodes 106” or “RAN node 106”) that enable the connections 118 and 120. As used herein, the terms “access node,” “access point,” or the like may describe equipment that provides the radio baseband functions for data or voice connectivity, or both, between a network and one or more users. These access nodes can be referred to as base stations (BS), gNodeBs, gNBs, eNodeBs, eNBs, NodeBs, RAN nodes, rode side units (RSUs), transmission reception points (TRxPs or TRPs), and the link, and can include ground stations (e.g., terrestrial access points) or satellite stations providing coverage within a geographic area (e.g., a cell), among others. As used herein, the term “NG RAN node” may refer to a RAN node 106 that operates in an 5G NR wireless communications system 100 (for example, a gNB), and the term “E-UTRAN node” may refer to a RAN node 106 that operates in an LTE or 4G wireless communications system 100 (e.g., an eNB). In some implementations, the RAN nodes 106 may be implemented as one or more of a dedicated physical device such as a macrocell base station, or a low power (LP) base station for providing femtocells, picocells or other like cells having smaller coverage areas, smaller user capacity, or higher bandwidth compared to macrocells.

In some implementations, some or all of the RAN nodes 106 may be implemented as one or more software entities running on server computers as part of a virtual network, which may be referred to as a cloud RAN (CRAN) or a virtual baseband unit pool (vBBUP). The CRAN or vBBUP may implement a RAN function split, such as a packet data convergence protocol (PDCP) split in which radio resource control (RRC) and PDCP layers are operated by the CRAN/vBBUP and other layer two (e.g., data link layer) protocol entities are operated by individual RAN nodes 106; a medium access control (MAC)/physical layer (PHY) split in which RRC, PDCP, MAC, and radio link control (RLC) layers are operated by the CRAN/vBBUP and the PHY layer is operated by individual RAN nodes 106; or a “lower PHY” split in which RRC, PDCP, RLC, and MAC layers and upper portions of the PHY layer are operated by the CRAN/vBBUP and lower portions of the PHY layer are operated by individual RAN nodes 106. This virtualized framework allows the freed-up processor cores of the RAN nodes 106 to perform, for example, other virtualized applications. In some implementations, an individual RAN node 106 may represent individual gNB distributed units (DUs) that are connected to a gNB central unit (CU) using individual F1 interfaces (not shown in FIG. 1). In some implementations, the gNB-DUs can include one or more remote radio heads or RFEMs, and the gNB-CU may be operated by a server that is located in the RAN 112 (not shown) or by a server pool in a similar manner as the CRAN/vBBUP. Additionally or alternatively, one or more of the RAN nodes 106 may be next generation eNBs (ng-eNBs), including RAN nodes that provide E-UTRA user plane and control plane protocol terminations toward the UEs 102, and are connected to a 5G core network (e.g., core network 114) using a next generation interface.

In vehicle-to-everything (V2X) scenarios, one or more of the RAN nodes 106 may be or act as RSUs. The term “Road Side Unit” or “RSU” refers to any transportation infrastructure entity used for V2X communications. A RSU may be implemented in or by a suitable RAN node or a stationary (or relatively stationary) UE, where a RSU implemented in or by a UE may be referred to as a “UE-type RSU,” a RSU implemented in or by an eNB may be referred to as an “eNB-type RSU,” a RSU implemented in or by a gNB may be referred to as a “gNB-type RSU,” and the like. In some implementations, an RSU is a computing device coupled with radio frequency circuitry located on a roadside that provides connectivity support to passing vehicle UEs 102 (vUEs 102). The RSU may also include internal data storage circuitry to store intersection map geometry, traffic statistics, media, as well as applications or other software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) or provide connectivity to one or more cellular networks to provide uplink and downlink communications, or both. The computing device(s) and some or all of the radiofrequency circuitry of the RSU may be packaged in a weatherproof enclosure suitable for outdoor installation, and can include a network interface controller to provide a wired connection (e.g., Ethernet) to a traffic signal controller or a backhaul network, or both.

Any of the RAN nodes 106 can terminate the air interface protocol and can be the first point of contact for the UEs 102. In some implementations, any of the RAN nodes 106 can fulfill various logical functions for the RAN 112 including, but not limited to, radio network controller (RNC) functions such as radio bearer management, uplink and downlink dynamic radio resource management and data packet scheduling, and mobility management.

In some implementations, the UEs 102 can be configured to communicate using orthogonal frequency division multiplexing (OFDM) communication signals with each other or with any of the RAN nodes 106 over a multicarrier communication channel in accordance with various communication techniques, such as, but not limited to, OFDMA communication techniques (e.g., for downlink communications) or SC-FDMA communication techniques (e.g., for uplink communications), although the scope of the techniques described here not limited in this respect. The OFDM signals can comprise a plurality of orthogonal subcarriers.

The RAN nodes 106 can transmit to the UEs 102 over various channels. Various examples of downlink communication channels include Physical Broadcast Channel (PBCH), Physical Downlink Control Channel (PDCCH), and Physical Downlink Shared Channel (PDSCH). Other types of downlink channels are possible. The UEs 102 can transmit to the RAN nodes 106 over various channels. Various examples of uplink communication channels include Physical Uplink Shared Channel (PUSCH), Physical Uplink Control Channel (PUCCH), and Physical Random Access Channel (PRACH). Other types of uplink channels are possible.

In some implementations, a downlink resource grid can be used for downlink transmissions from any of the RAN nodes 106 to the UEs 102, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The PDSCH carries user data and higher-layer signaling to the UEs 102. The PDCCH carries information about the transport format and resource allocations related to the PDSCH channel, among other things. It may also inform the UEs 102 about the transport format, resource allocation, and hybrid automatic repeat request (HARQ) information related to the uplink shared channel. Downlink scheduling (e.g., assigning control and shared channel resource blocks to the UE 102b within a cell) may be performed at any of the RAN nodes 106 based on channel quality information fed back from any of the UEs 102. The downlink resource assignment information may be sent on the PDCCH used for (e.g., assigned to) each of the UEs 102.

The PDCCH uses control channel elements (CCEs) to convey the control information. Before being mapped to resource elements, the PDCCH complex-valued symbols may first be organized into quadruplets, which may then be permuted using a sub-block interleaver for rate matching. In some implementations, each PDCCH may be transmitted using one or more of these CCEs, in which each CCE may correspond to nine sets of four physical resource elements collectively referred to as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. In LTE, there can be four or more different PDCCH formats defined with different numbers of CCEs (e.g., aggregation level, L=1, 2, 4, or 8).

Some implementations may use concepts for resource allocation for control channel information that are an extension of the above-described concepts. For example, some implementations may utilize an enhanced PDCCH (EPDCCH) that uses PDSCH resources for control information transmission. The EPDCCH may be transmitted using one or more enhanced CCEs (ECCEs). Similar to above, each ECCE may correspond to nine sets of four physical resource elements collectively referred to as an enhanced REG (EREG). An ECCE may have other numbers of EREGs.

The RAN nodes 106 are configured to communicate with one another using an interface 132. In examples, such as where the wireless communications system 100 is an LTE system (e.g., when the core network 114 is an evolved packet core (EPC) network), the interface 132 may be an X2 interface 132. The X2 interface may be defined between two or more RAN nodes 106 (e.g., two or more eNBs and the like) that connect to the EPC 114, or between two eNBs connecting to EPC 114, or both. In some implementations, the X2 interface can include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a master eNB to a secondary eNB; information about successful in sequence delivery of PDCP protocol data units (PDUs) to a UE 102 from a secondary eNB for user data; information of PDCP PDUs that were not delivered to a UE 102; information about a current minimum desired buffer size at the secondary eNB for transmitting to the UE user data, among other information. The X2-C may provide intra-LTE access mobility functionality, including context transfers from source to target eNBs or user plane transport control; load management functionality; inter-cell interference coordination functionality, among other functionality.

In some implementations, such as where the wireless communications system 100 is a 5G NR system (e.g., when the core network 114 is a 5G core network), the interface 132 may be an Xn interface 132. The Xn interface may be defined between two or more RAN nodes 106 (e.g., two or more gNBs and the like) that connect to the 5G core network 114, between a RAN node 106 (e.g., a gNB) connecting to the 5G core network 114 and an eNB, or between two eNBs connecting to the 5G core network 114, or combinations of them. In some implementations, the Xn interface can include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 102 in a connected mode (e.g., CM-CONNECTED) including functionality to manage the UE mobility for connected mode between one or more RAN nodes 106, among other functionality. The mobility support can include context transfer from an old (source) serving RAN node 106 to new (target) serving RAN node 106, and control of user plane tunnels between old (source) serving RAN node 106 to new (target) serving RAN node 106. A protocol stack of the Xn-U can include a transport network layer built on Internet Protocol (IP) transport layer, and a GPRS tunneling protocol for user plane (GTP-U) layer on top of a user datagram protocol (UDP) or IP layer(s), or both, to carry user plane PDUs. The Xn-C protocol stack can include an application layer signaling protocol (referred to as Xn Application Protocol (Xn-AP or XnAP)) and a transport network layer (TNL) that is built on a stream control transmission protocol (SCTP). The SCTP may be on top of an IP layer, and may provide the guaranteed delivery of application layer messages. In the transport IP layer, point-to-point transmission is used to deliver the signaling PDUs. In other implementations, the Xn-U protocol stack or the Xn-C protocol stack, or both, may be same or similar to the user plane and/or control plane protocol stack(s) shown and described herein.

The RAN 112 is shown to be communicatively coupled to a core network 114 (referred to as a “CN 114”). The CN 114 includes multiple network elements, such as network element 108a and network element 108b (collectively referred to as the “network elements 108”), which are configured to offer various data and telecommunications services to customers/subscribers (e.g., users of UEs 102) who are connected to the CN 114 using the RAN 112. The components of the CN 114 may be implemented in one physical node or separate physical nodes and can include components to read and execute instructions from a machine-readable or computer-readable medium (e.g., a non-transitory machine-readable storage medium). In some implementations, network functions virtualization (NFV) may be used to virtualize some or all of the network node functions described here using executable instructions stored in one or more computer-readable storage mediums, as described in further detail below. A logical instantiation of the CN 114 may be referred to as a network slice, and a logical instantiation of a portion of the CN 114 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more network components or functions, or both.

An application server 110 may be an element offering applications that use IP bearer resources with the core network (e.g., UMTS packet services (PS) domain, LTE PS data services, among others). The application server 110 can also be configured to support one or more communication services (e.g., VoIP sessions, PTT sessions, group communication sessions, social networking services, among others) for the UEs 102 using the CN 114. The application server 110 can use an IP communications interface 130 to communicate with one or more network elements 108a.

In some implementations, the CN 114 may be a 5G core network (referred to as “5GC 114” or “5G core network 114”), and the RAN 112 may be connected with the CN 114 using a next generation interface 124. In some implementations, the next generation interface 124 may be split into two parts, a next generation user plane (NG-U) interface 114, which carries traffic data between the RAN nodes 106 and a user plane function (UPF), and the SI control plane (NG-C) interface 126, which is a signaling interface between the RAN nodes 106 and access and mobility management functions (AMFs). Examples where the CN 114 is a 5G core network are discussed in more detail with regard to later figures.

In some implementations, the CN 114 may be an EPC (referred to as “EPC 114” or the like), and the RAN 112 may be connected with the CN 114 using an S1 interface 124. In some implementations, the S1 interface 124 may be split into two parts, an S1 user plane (S1-U) interface 128, which carries traffic data between the RAN nodes 106 and the serving gateway (S-GW), and the S1-MME interface 126, which is a signaling interface between the RAN nodes 106 and mobility management entities (MMEs).

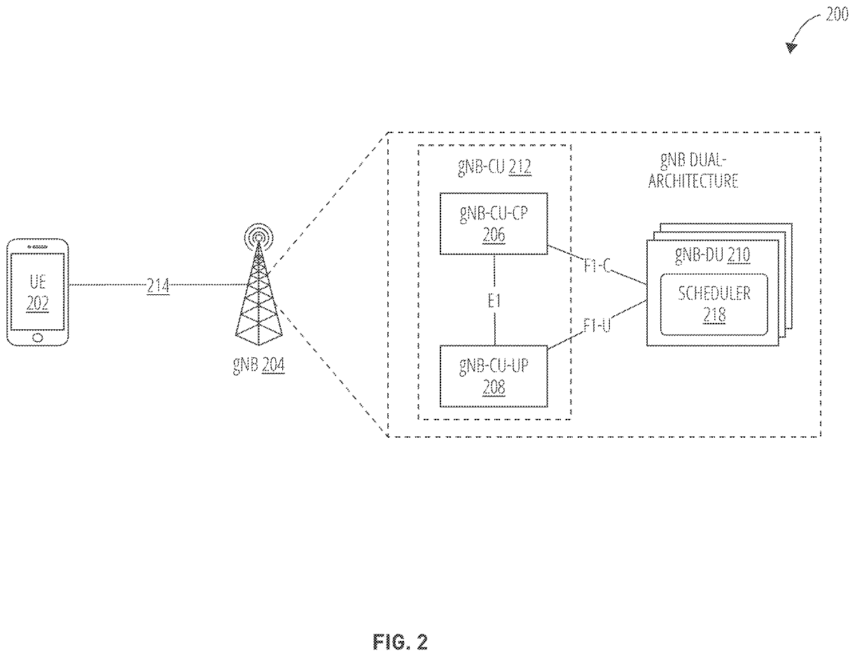

As previously discussed, in some implementations, an individual RAN node 106 may be implemented as a gNB dual-architecture comprising multiple gNB-DUs that are connected to a gNB-CU using individual F1 interfaces. An example of a gNB dual-architecture for a RAN node 106 is shown in FIG. 2.

FIG. 2 illustrates wireless communications system 200. The wireless communications system 200 is a sub-system of the wireless communications system 100 illustrated in FIG. 1. The wireless communications system 200 depicts a UE 202 connected to a gNB 204 over a connection 214. The UE 202 and connection 214 are similar to the UE 102 and the connections 118, 120 described with reference to FIG. 1. The gNB 204 is similar to the RAN node 106, and represents an implementation of the RAN node 106 as a gNB with a dual-architecture.

As depicted in FIG. 2, the gNB 204 is divided into two physical entities referred to a centralized or central unit (CU) and a distributed unit (DU). The gNB 204 may comprise a gNB-CU 212 and one or more gNB-DU 210. The gNB-CU 212 is further divided into a gNB-CU control plane (gNB-CU-CP) 206 and a gNB-CU user plane (gNB-CU-UP) 208. The gNB-CU-CP 206 and the gNB-CU-UP 208 communicate over an E1 interface. The gNB-CU-CP 206 communicates with one or more gNB-DU 210 over an F1-C interface. The gNB-CU-UP 208 communicates with the one or more gNB-DU 210 over an F1-U interface.

In some implementations, there is a single gNB-CU 212 for each gNB 204 that controls multiple gNB-DU 210. For example, the gNB 204 may have more than 100 gNB-DU 210 connected to a single gNB-CU 212. Each gNB-DU 210 is able to support one or more cells, where one gNB 204 can potentially control hundreds of cells in a 5G NR system.

The gNB-CU 212 is mainly involved in controlling and managing the overall network operations, performing tasks related to the control plane, such as connection establishment, mobility management, and signaling. It is responsible for non-real-time functionalities, which include policy decisions, routing, and session management among others. The gNB-CU-CP 206 and the gNB-CU-UP 208 provides support for higher layers of a protocol stack such as Service Data Adaptation Protocol (SDAP), Packet Data Convergence Protocol (PDCP) and RRC.

The gNB-DU 210 is responsible for real-time, high-speed functions, such as the scheduling of radio resources, managing the data plane, and performing error handling and retransmissions. The gNB-DU 210 provides support for lower layers of the protocol stack such as Radio Link Control (RLC), MAC layer, and PHY layer.

As depicted in FIG. 2, the gNB-DU 210 includes a scheduler 218. In the wireless communications system 100 and/or the wireless communications system 200, scheduling of measurement gaps for UE 202, including their configuration and allocation, is primarily handled by the base station of the serving cell, by the scheduler 218. The scheduler 218 is involved in real-time operations and is responsible for making immediate decisions regarding the allocation of radio resources, managing interference, and adhering to Quality of Service (QoS) requirements for different services and users. The scheduler 218 within the gNB-DU 210 makes decisions about resource allocation, including when and how to schedule measurement gaps for the UE 202. It considers the capabilities of the UE 202, mobility state, quality of service requirements, and current network conditions, among other factors.

Based on scheduling decisions, the gNB-DU 210 sends configuration information to the UE 202, instructing it when to perform measurements by allocating specific time intervals as measurement gaps. This information is usually conveyed through Radio Resource Control (RRC) messages, such as RRC Reconfiguration messages, among other types of messages. The RRC layer is responsible for managing the signaling between the UE 202 and the gNB-DU 210, including the signaling related to the configuration of measurement gaps. The RRC layer in the gNB-DU 210 thus plays a crucial role in orchestrating the scheduling and allocation of measurement gaps based on decisions made by the scheduler 218. After receiving the configuration, the UE 202 performs measurements during the allocated gaps and reports the results back to the network, enabling the gNB-DU 210 to make further decisions, such as handovers or beam adjustments.

Although the scheduler is located within the gNB-DU, it frequently interacts with the gNB-CU. The gNB-CU provides the necessary control and configuration information to the gNB-DU, which it uses to make real-time scheduling decisions and manage radio resources effectively. The configuration, policies, and user-specific QoS parameters provided by the gNB-CU aid the scheduler 218 in the gNB-DU to allocate resources and manage user traffic efficiently, catering to diverse service requirements in 5G and 6G networks.

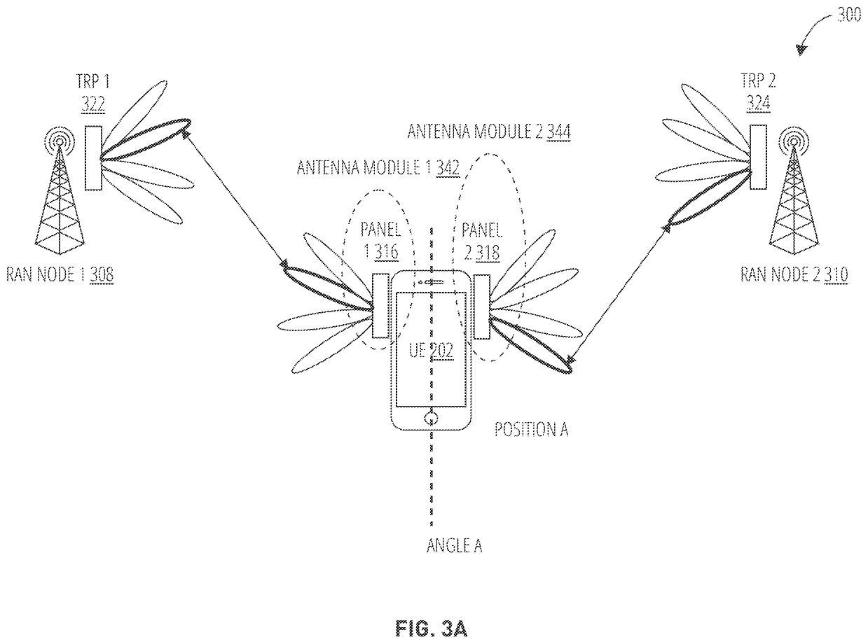

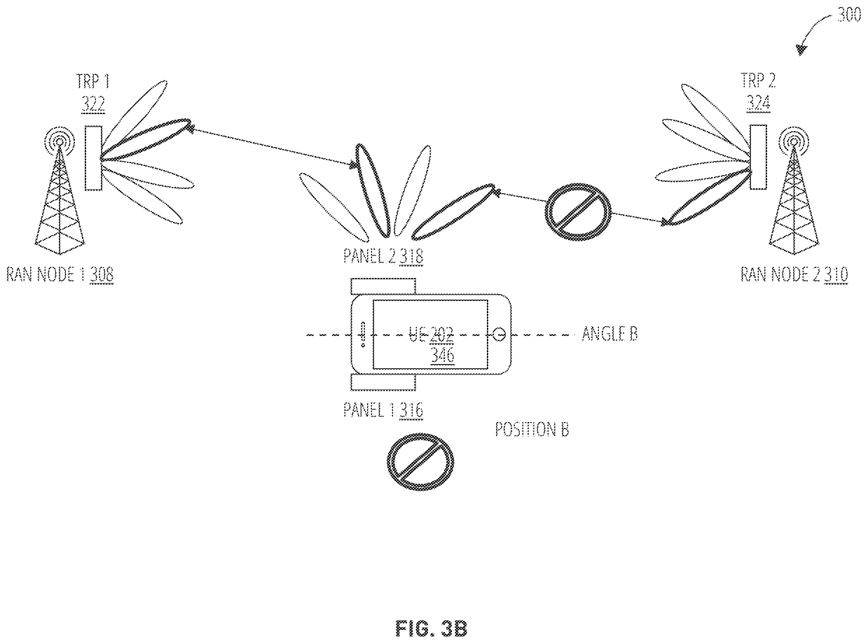

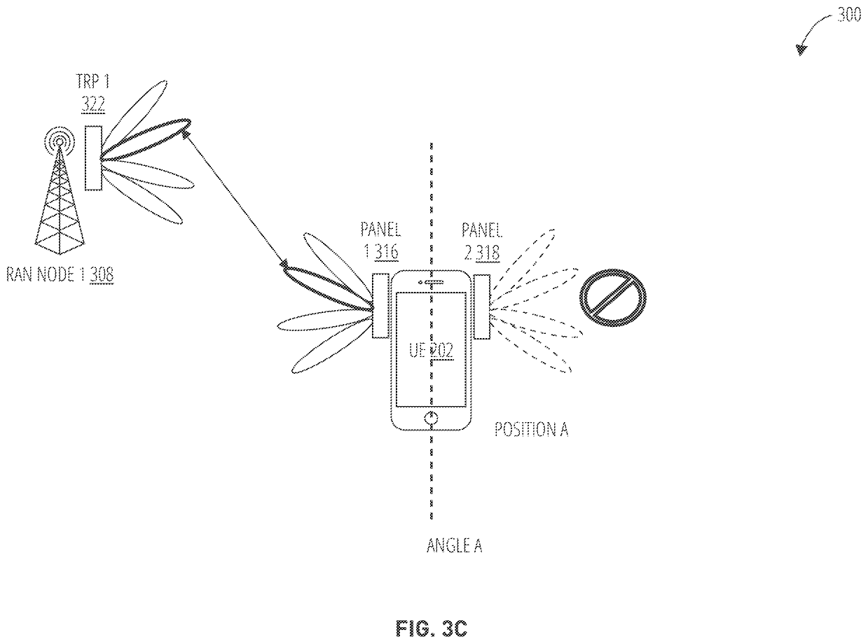

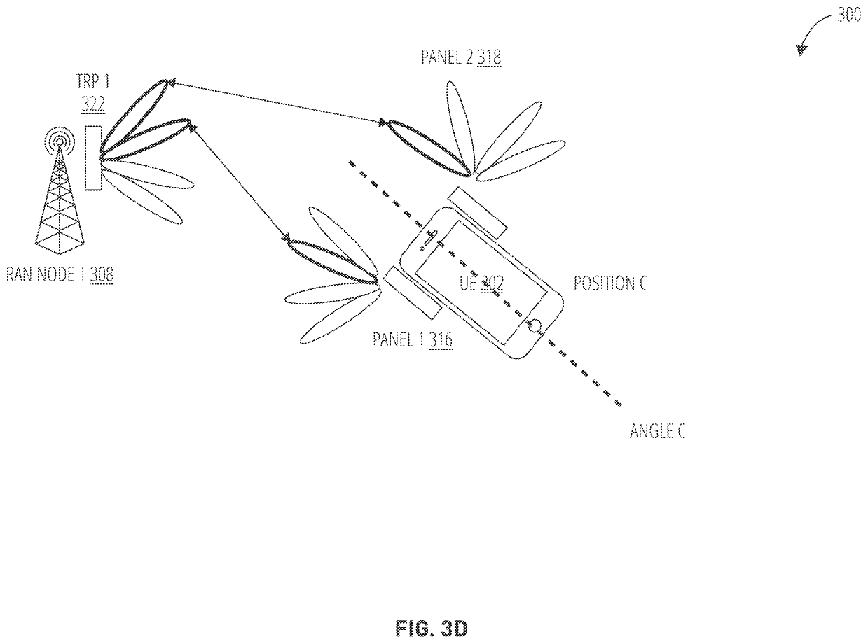

FIG. 3A illustrates an operating environment 300. The operating environment 300 illustrates operations for the wireless communications system 100 and/or the wireless communications system 200.

FIG. 3A illustrates an example implementation for a UE 202. The UE 202 may comprise multiple antenna modules, such as antenna module 1 342 and antenna module 2 344. The antenna module 1 342 may comprise a panel 1 316 and the antenna module 2 344 may comprise a panel 2 318. The antenna module 1 342 and antenna module 2 344, and respective panel 1 316 and panel 2 318, or on opposite sides of the UE 202. As such, each of panel 1 316 and panel 2 318 can cover half the available space. In this configuration, the UE 202 is capable of simultaneous reception operations since it has multiple antenna modules and multiple panels. FIG. 3A illustrates only two antenna modules each with one panel. However, the UE 202 may be equipped with more or less antenna modules, with each antenna module comprising multiple panels. Embodiments are not limited in this context.

As further depicted in FIG. 3A, the UE 202 is in communication with a set of RAN nodes, such as RAN node 1 308 and RAN node 2 310, which are similar to RAN node 106a and RAN node 106b, respectively. Both RAN node 1 308 and RAN node 2 310 operate as transmission and reception points (TRPs) for the wireless communications system 100 and/or wireless communications system 200. In the context of 3GPP, a TRP refers to a physical location or a collection of resources within a communication network where data is transmitted from and received by a UE or other network entities. In the context of cellular networks, such as 5G and 6G networks, these TRPs are commonly known as base stations or NodeBs. They serve as access points for a UE to connect to the network. These points enable the transmission and reception of data, voice, and other types of communication between the network infrastructure and the UE. The TRPs maintain connectivity and efficient communication between the network and mobile devices, enabling features such as call establishment, call handover, and data transfer. They are responsible for managing radio resources and facilitating wireless communication within the network.

Referring again to FIG. 3A, the RAN node 1 308 may comprise a TRP 1 322. The RAN node 2 310 may comprise a TRP 2 324. For example, the RAN node 1 308 may comprise a serving cell (e.g., a PCell) for the UE 202 and the RAN node 2 310 may comprise a neighbor cell (e.g., SCell) for the UE 202. The UE 202 may comprise a mobile device moving between communication envelopes for the RAN node 1 308 and the RAN node 2 310, and therefore the UE 202 may need to perform measurements of intra-frequency or inter-frequency signals for handover operations, beamforming operations, or other UE and/or network operations.

The UE 202 is capable of simultaneous reception operations to simultaneous receive and decode signals from the RAN node 1 308 and the RAN node 2 310 since it has multiple antenna modules and multiple panels. For example, the panel 1 316 of the antenna module 1 342 may receive signals from the TRP 1 322 of the RAN node 1 308 on one frequency set (FS). Concurrently, at approximately the same time, the panel 2 318 of the antenna module 2 344 may receive signals from the TRP 2 324 of the RAN node 2 310 on a same FS or different FS.

One reason the UE 202 is capable of simultaneous reception with the RAN node 1 308 and the RAN node 2 310 is because of various geospatial attributes of the UE 202 relative to a defined reference point, such as the Earth surface, a user, the RAN node 1 308 and the RAN node 2 310, or other defined reference points. Geospatial attributes refers to information or data that is associated with a specific geographic location or has a spatial or geographical component. It encompasses data that is related to the Earth's surface, such as coordinates, elevation, boundaries, and other spatial attributes. Geospatial data can be represented in various forms, including maps, satellite imagery, aerial photographs, global positioning system (GPS) coordinates, and other location-based data sources. It provides a framework for analyzing, visualizing, and understanding the relationships and patterns within geographic and spatial contexts.

The UE 202 may collect geospatial data associated with the UE 202 using any number or type of suitable sensors and associated software and algorithms, such as a GPS system, a gyroscope sensor, an accelerometer, a magnetometer, a barometer, a camera, a light detection and ranging (LIDAR) sensor, a radio detection and ranging (RADAR) sensor, a proximity sensor, and so forth. Embodiments are not limited to these examples.

Due to movement of the UE 202, it is possible that the UE 202 changes its position and/or angle, which can be detected using one or more sensors of the UE 202. In one embodiment, a position of the UE 202 generally refers to a physical location of the UE 202 in a 3D Cartesian coordinate system (e.g., x-axis, y-axis, z-axis) or map coordinates (e.g., latitude, longitude, and altitude). An example of a position for the UE 202 may comprise a location, such as San Francisco or New York City. In one embodiment, an angle of the UE 202 may generally refer to an angle (e.g., 0-360 degrees) of a surface of the UE 202 relative to a fixed point (e.g., a user, a base station, a piece of furniture, etc.) in a 3D Cartesian coordinate system. For example, a screen may be 0 degrees vertical relative to a user's face, 180 degrees horizontal relative to the user's face, or in-between such as titled 90 degrees, placed face down on a surface of a table, and so forth. Any geospatial coordinates and coordinate systems may be used for a given implementation. Embodiments are not limited in this context.

As depicted in FIG. 3A, the UE 202 is at a first position A represented using 3D coordinates and its location may be calculated relative to a fixed point, such as a transmission source such as the RAN node 1 308 or RAN node 2 310, the Earth's surface as represented in 3D coordinates, a user of the UE 202, or some other known fixed point. For example, the first position A may refer to an initial altitude of the UE 202, an initial distance between the UE 202 and the RAN node 1 308 and/or the RAN node 2 310 along an x-axis, y-axis or z-axis of a 3D coordinate system, and so forth. The UE 202 is also at a first angle A with the position A of the UE 202, the first angle A represents an orientation of the UE 202 relative to a fixed point, such as a transmission source such as the RAN node 1 308 or RAN node 2 310, the Earth's surface as represented in 3D coordinates, a user of the UE 202, or some other known fixed point. For example, the first angle A may refer to an initial orientation of the UE 202, such as vertical to the ground along a y-axis of a 3D coordinate system, horizontal to the ground along an x-axis of the 3D coordinate system, or at an angle to the ground along a z-axis of the 3D coordinate system.

FIG. 3B illustrates another view of the operating environment 300. The operating environment 300 illustrates operations for the wireless communications system 100 and/or the wireless communications system 200.

As with FIG. 3A, FIG. 3B illustrates the UE 202 comprising multiple antenna modules, such as antenna module 1 342 and antenna module 2 344. The antenna module 1 342 may comprise a panel 1 316 and the antenna module 2 344 may comprise a panel 2 318. In this configuration, the UE 202 is capable of simultaneous reception operations since it has multiple antenna modules and multiple panels.

In contrast to FIG. 3A, however, the UE 202 is at a position B and an angle B that is different from the position A and the angle A, respectively, of the UE 202 as depicted in FIG. 3A. In position B, the UE 202 may be closer to or further from the RAN node 1 308 and/or the RAN node 2 310. At angle B, the UE 202 is oriented horizontal to the ground along a y-axis of the 3D coordinate system. In position B and angle B, the panel 1 316 of the antenna module 1 342 is incapable of receiving signals from either the TRP 1 322 of the RAN node 1 308 or the TRP 2 324 of the RAN node 2 310. As such, the panel 2 318 of the antenna module 2 344 attempts to perform simultaneous reception of signals from the TRP 1 322 and the TRP 2 324. Since the antenna module 2 344 only has a single panel 2 318, however, the UE 202 is only capable of receiving signals from the TRP 1 322 of the RAN node 1 308 and it is incapable of performing simultaneous reception of signals from the TRP 2 324 of the RAN node 2 310.

In position A and angle A, only the panel 2 318 of the antenna module 2 344 will work. The UE 202 attempts to cover both TRP 1 322 and TRP 2 324 using the panel 2 318. Panel 1 316 cannot receive a signal from TRP 2 324. This raise the challenge of whether the UE 202 can receive signals from two directions by using only the panel 1 316. According to the agreement of a radio-frequency (RF) session, one single panel 1 316 can only receive from a single direction, such as from TRP 1 322. Therefore, the UE 202 cannot perform simultaneous reception from both TRP 1 322 and TRP 2 324 at the same time.

When the UE 202 is only equipped with two panels, such as panel 1 316 and panel 2 318, there are two possible scenarios that may occur according to the relative position of TRP 1 322 and TRP 2 324 to the panel 1 316 and the panel 2 318, respectively. First, when signals from both TRP 1 322 and TRP 2 324 are in the coverage area of panel 1 316 and panel 2 318, the UE 202 can perform simultaneous reception. Second, when the UE 202 moves to a position and/or angle to cause signals from one of the TRP 1 322 or TRP 2 324 to be outside of coverage by one panel 1 316 or the other panel 2 318, the UE 202 cannot perform simultaneous reception until the UE 202 again changes its position and/or angle relative to the TRP 1 322 and/or the TRP 2 324. Consequently, a relative position and angle between the TRPs and the panels may change due to movement, thereby causing the UE 202 to move in or out of coverage of the transmission envelopes of the TRP 1 322 or the TRP 2 324.

Due to the potential of constant movement of the UE 202, the scheduler 218 for the gNB 204 (as discussed with reference to FIG. 2) and/or the UE 202 needs to implement a set of dynamic scheduling restrictions and dynamic measurement restrictions for implementation by the UE 202. An example of a restriction may comprise: (1) when the UE 202 is receiving data from one TRP 1 322 and measuring layer 1 (L1) reference signals from another TRP 2 324; and (2) when L1 measurement operations have a higher priority than receiving data; then (3) the UE 202 will have a scheduling restriction for data. These and other scenarios require the UE 202 and the network to implement a set of dynamic scheduling and measurement restrictions as the panels of the UE 202 move in and out of coverage of a TRP.

Various example scenarios for a UE 202 that is capable of simultaneous reception or actively engaging in simultaneous reception with two TRPs, and where movement of the UE 202 causes one of the panels for the UE 202 to no longer receive signals from one of the two TRPs, are outlined as follows. For example, when both panels are measuring reference signals (RS+RS), a measurement restriction for one or both panels will change over time. When one panel is measuring a reference signal and another panel is receiving data signals (RS+DS), movement may cause one panel to no longer receive signals from one TRP. A scheduling restriction or measurement restriction for one or both panels will also change over time. When the UE 202 is receiving data from two TRPs simultaneously, movement may cause the UE 202 to no longer continue receiving data from one of the TRPs by changing beam directions since only one panel will work. The UE 202 can only receive signals from one TRP by using the remaining panel. As such, the UE 202 will stop simultaneous reception and link recovery can no longer work. Further, when the UE 202 is receiving data from two TRPs simultaneously, and movement of the UE 202 causes one of the panels to no longer work, the UE 202 cannot continue receiving data from one of the TRPs by changing beam directions, and link recovery cannot work as well. RAN4 needs to define, for these and other applicable scenarios for simultaneous reception (e.g., two TRPs are in the coverage of two panels), a set of scheduling restrictions and/or measurement restrictions for the network and/or the UE 202.

FIG. 3C illustrates another view of the operating environment 300. The operating environment 300 illustrates operations for the wireless communications system 100 and/or the wireless communications system 200.

As with FIG. 3A and FIG. 3B, FIG. 3C illustrates the UE 202 comprising multiple antenna modules, such as antenna module 1 342 and antenna module 2 344. The antenna module 1 342 may comprise a panel 1 316 and the antenna module 2 344 may comprise a panel 2 318. In this configuration, the UE 202 is capable of simultaneous reception operations since it has multiple antenna modules and multiple panels. Further, FIG. 3C illustrates the UE 202 in position A and angle A.

In contrast to FIG. 3A and FIG. 3B, the FIG. 3C illustrates a case where there is only a single RAN node 1 308 with a single TRP 1 322 or two TRPs co-located by the RAN node 1 308. From the 3GPP work item description (WID), it did not preclude that UE 202 may also receive two signals from the single TRP 1 322 if they are different quality of service (QoS) class identifier for default bearer (QCL-TypeD) signals. For the single TRP 1 322 case, in a legacy single panel case, there is a scheduling restriction for data signals plus and L1 synchronization signal block (SSB) (Data+L1 SSB) and data plus L1 channel state reference signal (CSI-RS) (Data+L1 CSI-RS) for frequency range 2 (FR2). There is also a measurement restriction for SSB plus CSI-RS (SSB+CSI-RS) in overlapped symbols. With multi-receivers, it is possible that the UE 202 can perform simultaneous reception of two signals. However, the case of whether simultaneous reception from a single TRP or co-located TRP needs consideration. This scenario may depend, at least in part, on a relative location between the TRP 1 322 and the panel 1 316 or the panel 2 318 of the UE 202.

For example, as depicted in FIG. 3C, when the UE 202 is in position A and angle A, only the panel 1 316 of the UE 202 is capable of receiving signals from the TRP 1 322 of the RAN node 1 308. The panel 2 318 is blocked from receiving signals from the TRP 1 322. This remains true even when the RAN node 1 308 implements multiple TRPs, such as TRP 1 322 and TRP 2 324, as co-located TRPs. This scenario requires dynamic scheduling restrictions and measurement restrictions. The UE 202 may also need to implement additional UE capability.

FIG. 3D illustrates another view of the operating environment 300. The operating environment 300 illustrates operations for the wireless communications system 100 and/or the wireless communications system 200.

As with FIG. 3A through FIG. 3C, FIG. 3D illustrates the UE 202 comprising multiple antenna modules, such as antenna module 1 342 and antenna module 2 344. The antenna module 1 342 may comprise a panel 1 316 and the antenna module 2 344 may comprise a panel 2 318. In this configuration, the UE 202 is capable of simultaneous reception operations since it has multiple antenna modules and multiple panels.

Further, FIG. 3D illustrates the UE 202 in position C and angle C. In position C and angle C, both of the panel 1 316 and the panel 2 318 can simultaneously receive signals from the TRP 1 322 of the RAN node 1 308 on different frequencies. This remains true even when the RAN node 1 308 implements multiple TRPs, such as TRP 1 322 and TRP 2 324, as co-located TRPs. This scenario also requires dynamic scheduling restrictions and measurement restrictions. The UE 202 may also need to implement additional UE capability.

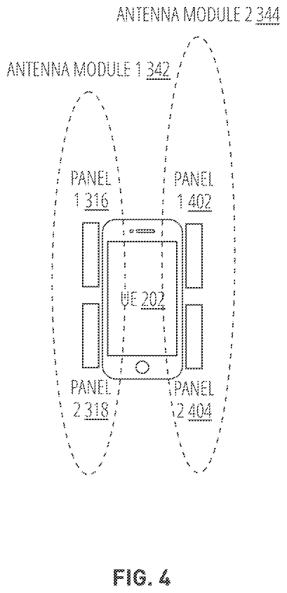

FIG. 4 illustrates another example implementation for the UE 202. As depicted in FIG. 4, the UE 202 comprises a pair of antenna modules, such as antenna module 1 342 and antenna module 2 344. In this example, each of the antenna module 1 342 and the antenna module 2 344 comprise multiple panels. For example, the antenna module 1 342 comprises the panel 1 316 and the panel 2 318, while the antenna module 2 344 comprises a panel 1 402 and a panel 2 404.

When the UE 202 is equipped with two antenna modules and there are two panels in each antenna module, the UE 202 may receive two signals simultaneously all the time. The UE 202 can also be configured with more panels, while only activating two of them simultaneously. Normally, the UE 202 will activate the two panels on opposite sides of the UE 202, such as the panel 1 316 and the panel 1 402, for example. When a signal from one TRP 1 322 co-located with TRP 2 324 is out of coverage of one panel, such as panel 1 402, thereby causing all the beams to fail, the UE 202 may activate another panel on the same side of the UE 202 as the remaining operating panel, such as both panel 1 316 and panel 2 318, to maintain simultaneous reception. However, it may cause a loss in signal reception.

When the UE 202 is equipped with two antenna modules and there are two panels in each antenna module, when the signal from one TRP is out of coverage of one panel, the UE 202 may activate the panel on the same side of UE to keep simultaneous reception. RAN4 may need to discuss whether to introduce UE capability to support two antenna modules with two panels in each module. RAN4 may also need to introduce UE capability to support two antenna modules where there are two panels in each module. Since a relative position of TRPs to two panels may change due to movement, and signals from one TRP maybe out of the coverage of one panel, it may need further definition as to how to design dynamic scheduling restriction and measurement restriction. Considering a scenario where measurement restriction cannot always be applied, applicable condition or threshold needs to be defined in order to differentiate the different scenarios for scheduling restriction and measurement restriction.

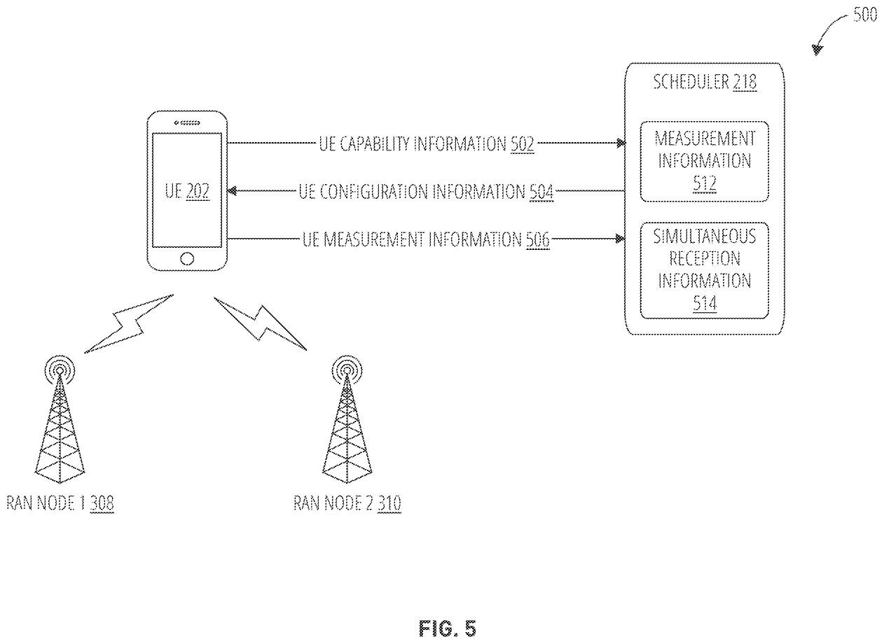

FIG. 5 illustrates an operating environment 500. The operating environment 500 illustrates operations for the wireless communications system 100 and/or the wireless communications system 200.

As depicted in FIG. 5, the UE 202 is in communication with a set of RAN nodes, such as RAN node 1 308 and RAN node 2 310, which are similar to RAN node 106a and RAN node 106b, respectively. For example, the RAN node 1 308 may comprise a serving cell (e.g., a PCell) for the UE 202 and the RAN node 2 310 may comprise a neighbor cell (e.g., SCell) for the UE 202. The UE 202 may comprise a mobile device moving between communication envelopes for the RAN node 1 308 and the RAN node 2 310, and therefore the UE 202 may need to perform measurements of intra-frequency or inter-frequency signals for handover operations, beamforming operations, or other UE and/or network operations.

The UE 202 may communicate with the scheduler 218 to coordinate simultaneous reception operations and/or measurement operations for the UE 202. The UE 202 may send UE capability information 502 to the scheduler 218. The scheduler 218 may receive the UE capability information 502, and generate UE configuration information 504 for the UE 202. The scheduler 218 may send the UE configuration information 504 to the UE 202. The UE 202 may configure its simultaneous reception operations and/or measurement operations in accordance with the UE configuration information 504. The UE 202 may then take measurements of for various measurement objects (MOs) associated with the RAN node 1 308 and/or the RAN node 2 310. The UE 202 may send the UE measurement information 506 to the scheduler 218. The scheduler 218 may then update network settings and send new control directives to the UE 202 based on the UE measurement information 506.

During RRC connection setup, the UE 202 sends an RRC Connection Request message to the gNB 204. The RRC Connection Request includes information such as a UE identity and establishment cause (e.g., mo-data, mo-signalling, etc.). Upon receiving the RRC Connection Request message and after processing it, the gNB 204 sends an RRC Connection Setup message to the UE 202. This message carries the initial configuration for the UE 202, including a Signalling Radio Bearer 1 (SRB1) configuration and other parameters necessary for the UE 202 to communicate in RRC Connected mode. SRB1 is used for transmitting RRC and Non-Access Stratum (NAS) messages. Once the UE 202 receives and processes the RRC Connection Setup message, it moves to the RRC Connected state and responds with an RRC Connection Setup Complete message. This message usually carries the selected public land mobile network identifier (PLMN-ID) and initial NAS message, which typically includes the Service Request message or Attach Request message to initiate NAS level procedures for network attachment and service accessibility. The RRC Connection Setup process results in the establishment of SRB1, allowing the UE 202 and gNB 204 to exchange RRC and NAS messages. The UE moves from RRC Idle state to RRC Connected state, enabling it to initiate the NAS procedures to access network services. The initial configurations provided in the RRC Connection Setup message will enable the UE 202 to communicate with the network in the RRC Connected state effectively.

Sometime during or after RRC connection setup, the UE 202 sends UE capability information 502 to the gNB 204. The UE capability information 502 may include measurement information 512, simultaneous reception information 514, or a combination of measurement information 512 and simultaneous reception information 514.

The UE capability information 502 includes measurement information 512 about UE capabilities, including whether the UE 202 is capable of communicating with or without measurement gaps. The measurement information 512 may comprise information describing measurement capabilities of the UE 202, including whether the UE 202 needs measurement gaps or is capable of operating without measurement gaps. For example, the UE 202 may be equipped with advanced receivers capable of performing measurements on different frequency simultaneously without needing to interrupt the primary serving cell communication, multiple antennas and advanced signal processing to manage concurrent reception from different cells or frequencies allowing seamless measurements, parallel processing capabilities to allow a UE to handle multiple tasks concurrently, enhanced measurement reporting capabilities, and advanced interference measurement techniques to enable the UE 202 to isolate and filter out interference while performing measurements. The UE 202 may include such capabilities to support measurement operations without a measurement gap in the measurement information 512. Alternatively, the measurement information 512 may include one or more values to indicate whether it requires a measurement gap or does not require a measurement gap.

The UE capability information 502 also includes simultaneous reception information 514. As previously described, the term “simultaneous reception” may refer to receiving two or more signals in a same or overlapping OFDM symbols. For instance, the overlapping signals may comprise various combinations of a data signal (DS) and a reference signal (RS). In this case, simultaneous reception may refer to the UE 202 receiving multiple data signals (DS+DS), multiple reference signals (RS+RS), or a combination of data signals and reference signals (DS+RS or RS+DS). Embodiments are not limited to these types of signals or signal permutations.

The simultaneous reception information 514 includes information related to simultaneous reception capabilities for the UE 202. Examples of simultaneous reception information 514 includes without limitation radio antenna information including a number of radio antenna modules and a number of panels per radio antenna module, TRP information including a number of TRPs detected by the UE 202, position and/or angle information for the UE 202, operational modes for the UE 202, and other types of information related to simultaneous reception.

Simultaneous reception by the UE 202 may depend upon a number of different factors, as outlines in TABLE 1.

TABLE 1

| TYPE | EXAMPLES |
|---|---|
| TRP Type | Single TRP, Intra-Cell multi-TRP (mTRP) |
| Signal Type | Data + Data, RS + RS, Data + RS, |
| | RS + Data |
| Reference Signal | Synchronization Signal Block (SSB), |
| (RS) Type | Channel State |
| | Information (CSI) Reference Signal |
| | (RS) (CSI-RS) |
| RS Measurement Type | Layer 1 (L1) Measurement, Layer 3 |
| | (L3) Measurement |

Because there are so many scenario combinations for RS measurement type, description herein may focus on the L1 measurement at first.

In one embodiment, for example, the UE 202 may be capable of simultaneous reception for a single TRP, such as TRP 1 322 or TRP 2 324. For the single TRP case, in a legacy single antenna module case, there is scheduling restriction for Data+L1 SSB and Data+L1 CSI-RS for frequency range 2 (FR2). There is also measurement restriction for the SSB+CSI-RS case. For example, when the SSB for L1-RSRP measurement on one component carrier (CC) is in the same OFDM symbol as CSI-RS for rank level mapping (RLM), best fitting distribution (BFD), cell broadcast service (CBD) or L1 reference signal received power (RSRP) (L1-RSRP) measurement on the same CC or different CCs in the same band, the UE 202 is required to measure only one of SSB for L1-RSRP measurement or CSI-RS. With multi-receivers, it is possible that the UE 202 can perform simultaneous reception of two signals.

For the single TRP scenario, the UE 202 can perform simultaneous reception for multiple signals as outlines in Table 2.

TABLE 2

| SIGNAL TYPE | EXAMPLES |
|---|---|
| Data + RS | Data + L1 CSI-RS, Data + L1 SSB |
| RS + RS | L1 CSI + L1 SSB |

For a simultaneous reception for intra-cell multi-TRP scenario, the UE 202 can perform simultaneous reception for: (1) RS+RS; (2) RS+Data; or (3) Data+Data.

For the simultaneous reception scenario of RS+RS, the RS type may comprise SSB and CSI-RS. Consider a scenario of simultaneous reception of SSB+SSB from two TRPs. For intra-cell TRP, if the SSB index configuration for two TRPs are different, the SSB index will not overlap. The UE 202 will not receive from the SSBs simultaneously from two TRPs. There is no such scenario.

If the SSB index configuration are the same for two TRPs, multiple SSB with a same SSB index from two TRPs will overlap. In a legacy single panel case, the UE 202 may not be able to differentiate SSBs from two TRPs since the cell identifier (ID) is the same. When the UE 202 has two panels, the UE 202 will need to differentiate SSBs from two TRPs with the same cell ID. As with a single panel, the UE 202 may be unable to differentiate multiple SSBs from two TRPs. Therefore, the UE 202 may not be able to perform simultaneous reception of SSB+SSB from two intra-cell TRPs.

For the simultaneous reception scenario of CSI-RS+CSI-RS from two TRPs, it is possible that two different CSI-RS indexes are configured for two TRP, where the two CSI-RS exist in one symbol while in a different frequency domain. Therefore, it is possible that the UE 202 will receive two CSI-RSs from two TRPs simultaneously.

For the simultaneous reception scenario of SSB+CSI-RS from two TRPs, it is possible that the UE 202 can receive both SSB and CSI-RS signals simultaneously.

For the simultaneous reception scenario of Data+RS, the UE 202 may receive data from one TRP and perform measurement for SSB and CSI-RS for another TRP.

For the simultaneous reception scenario of Data+Data, the UE 202 may perform simultaneous reception of data from two TRPs.

The options for simultaneous scenario for intra-cell multi-TRP (mTRP) may be summarized in TABLE 3.

TABLE 3

| SIGNAL TYPE | EXAMPLES |
|---|---|
| Data + RS | Data + L1 CSI-RS, Data + L1 SSB |
| RS + RS | L1 CSI + L1 CSI-RS, L1 CSI + L1 SSB |
| Data + Data | Any |

There may be a need for RRM enhancement on scheduling restriction for intra-cell mTRP. The scheduling restrictions are different depending on how many L1 measurements the UE 202 is performing since the UE 202 can receive signals from two directions simultaneously.

Scheduling restrictions for performing L1 measurements for one TRP may vary based on a number of factors. In the legacy single panel case, there may be a scheduling restriction for data when data is overlapped with RS for L1-RSRP. Equipped with multiple-panels, however, the UE 202 may receive data from a TRP simultaneously when performing L1 measurement for another TRP.

This leads to two possible scenarios: (1) SSB+Data; and (2) CSI-RS+Data case. For the SSB+Data case, whether there is a scheduling restriction depends on the UE capability simultaneousRxDataSSB-DiffNumerology and the subcarrier spacing (SCS) between the SSB signal and the data signal. If the SCS is different and the UE 202 does not support simultaneousRxDataSSB-DiffNumerology, the UE 202 may not be able to transmit or receive data on the SSB resource location for L1 measurement. For the CSI-RS+Data case, there is no scheduling restriction since the SCS of the two TRPs are the same.

Scheduling restrictions for performing L1 measurements for two TRPs may vary based on a number of factors. For the scenarios that the UE 202 is performing L1 measurement for two TRPs simultaneously, the UE 202 may not be able to receive data anymore since the UE 202 can only receive signals from two directions. L1 measurement has a higher priority than data transmission. As such, there will still be a scheduling restriction for data for this case. Two L1 measurements can be CSI+CSI or CSI-RS+SSB.

For intra-cell mTRP, the scheduling restrictions are as follows. When the UE 202 is only performing L1 measurement for one TRP, there is scheduling restriction for SSB based measurement if the SCS between data and SSB is different and the UE 202 does not support simultaneousRxDataSSB-DiffNumerology. There is no scheduling restriction for CSI-RS based measurements. When the UE 202 is performing L1 measurements for two TRP simultaneously, there is scheduling restriction for CSI-RS+CSI-RS or SSB+CSI-RS

RRM enhancement on measurement restriction for intra-cell mTRP are as follows. When the UE 202 performs simultaneous reception of CSI-RS+CSI-RS from two TRPs, and since the SCS of the two TRPs are the same, there is no measurement restriction when CSI-RS are received from the two TRPs by the multiple panels of the UE 202. When the UE 202 performs simultaneous reception of SSB+CSI-RS from two TRPs, and when the SSB and CSI-RS are overlapped from different TRPs, whether there is measurement restriction will depend on whether the UE 202 supports simultaneousRxDataSSB-DiffNumerology and the SCS between SSB and CSI-RS. If the SCS is different and the UE 202 does not support simultaneousRxDataSSB-DiffNumerology, the UE 202 can only measure one of the two RS.

For intra-cell multi-TRP, the measurement restrictions are as follows: (1) there is no measurement restriction for simultaneous reception of CSI-RS+CSI-RS from two TRPs; and (2) there is measurement restriction if the SCS between SSB and CSI-RS is different and the UE 202 does not support simultaneousRxDataSSB-DiffNumerology.

3GPP Release 18 attempts to capture the above-described scheduling restrictions and/or measurement restrictions in one or more versions of the 3GPP TS 38.133 Standards, particularly those sections relating to RRM requirements for NR FR2 multi-Rx chain DL reception, for example. For example, 3GPP Release 18 may include changes to Sections 8.1.7, 8.5.7, and 8.18.8, and other sections, as presented below.

### 8.1.7 Scheduling Availability of UE During Radio Link Monitoring

8.1.7.3 Scheduling Availability of UE Performing Radio Link Monitoring on FR2

The following scheduling restriction applies due to radio link monitoring on an FR2 serving PCell and/or PSCell.
If the RLM-RS is CSI-RS which is type-D QCLed with active TCI state for PDCCH or PDSCH, and the CSI-RS is not in a CSI-RS resource set with repetition ON, or
For FR2-1 for PCell, for UE supporting/TBD —multi-rx capability/and is configured to receive two PDSCH transmission occasions from two different QCL sources on PCell, there are no scheduling restrictions for the PDSCHs due to beamfailure detection performed based on the CSI-RS, when following conditions are met:

The CSI-RS is not in a CSI-RS resource set with repetition ON,

The CSI-RS has same QCL source as the active TCI state of one of the PDSCHs and has ditferent QCL-TypeD from the other PDSCH,

The CSI-RS and both of the PDSCHs are on the same OFDM symbol(s),

FFS: The CSI-RS and only one of the PDSCHs with different QCLed typeD are on the same OFDM symbol(s),

Resources of the active TCI states for the two PDSCHs have been reported as a resource group in Rel-17 group-based RSRP report.

[FFS how to Capture UE is Activated with Multi-Rx Operation]
There are no scheduling restrictions due to radio link monitoring based on the CSI-RS.
Otherwise
For FR2-1 or the RLM-RS is not using 480 kHz SCS or 960 kHz SCS on FR2-2, the UE is not expected to transmit PUCCH, PUSCH or SRS or receive PDCCH, PDSCH or CSI-RS for tracking or CSI-RS for CQI on RLM-RS symbols to be measured for radio link monitoring.
For FR2-2 and the RLM-RS is using 480 kHz SCS or 960 kHz SCS, the UE is not expected to transmit PUCCH, PUSCH or SRS or receive PDCCH, PDSCH or CSI-RS for tracking or CSI-RS for CQI on RLM-RS symbols to be measured for radio link monitoring, and on one data symbol before each RLM-RS symbol to be measured and one data symbol after each RLM-RS symbol to be measured.

When intra-band carrier aggregation in FR2 is performed, the scheduling restrictions on FR2 serving PCell or PSCell applies to all serving cells in the same band-on the symbols that fully or partially overlap with restricted symbols.

When inter-band carrier aggregation in FR2 is performed, there are no scheduling restrictions on FR2 serving cell(s) in the bands for the following cases, provided that UE is capable of independent beam management on this FR2 band pair:
when performing radio link monitoring performed on FR2 serving PCell or PSCell in different bands,
the UE is configured with same or different numerology between SSB on one FR2 band and data on the other FR2 band.

For FR2, if following conditions are met,
UE has been notified about system information update through paging,
The gap between UE's reception of PDCCH that UE monitors in the Type2-PDCCH CSS set and that notifies system information update, and the PDCCH that UE monitors in the Type0-PDCCH CSS set, is greater than 2 slots,

For the SSB for RLM and CORESET for RMSI scheduling multiplexing patterns 3, UE is expected to receive the PDCCH that UE monitors in the Type0-PDCCH CSS set, and the corresponding PDSCH, on SSB symbols to be measured for RLM; and

For the SSB for RLM and CORESET for RMSI scheduling multiplexing patterns 2, UE is expected to receive PDSCH that corresponds to the PDCCH that UE monitors in the Type0-PDCCH CSS set, on SSB symbols to be measured for RLM.

### 8.5.7 Scheduling Availability of UE During Beam Failure Detection

### 8.5.7.3 Scheduling Availability of UE Performing Beam Failure Detection on FR2

The following scheduling restriction applies due to beam failure detection.
For the case where no RSs are provided for BFD, or when CSI-RS is configured for BFD is explicitly configured and is type-D QCLed with active TCI state for PDCCH or PDSCH, and the CSI-RS is not in a CSI-RS resource set with repetition ON, or
There are no scheduling restrictions due to beam failure detection performed based on the CSI-RS.
For the case when UE supporting [multi-Rx capability] in FR2-1 is configured to receive two PDSCH transmission occasions from two different QCL sources on PCell, there are no scheduling restrictions for the PDSCHs due to beam failure detection performed based on the CSI-RS, when following conditions are met:
the CSI-RS configured for BFD is not in a CSI-RS resource set with repetition ON, and
the CSI-RS configured for BFD has same QCL source as the active TCI state of one of PDSCHs and has different QCL-TypeD from the other PDSCH, and
the CSI-RS configured for BFD and both PDSCHs are on the same OFDM symbols, and
Resources of the active TCI states for the two PDSCHs have been reported as a resource group in Rel-17 group-based RSRP report
Editor's Note 1: FFS the CSI-RS and only one of the PDSCHs with different QCLed typeD are on the same OFDM symbol(s)
Editor's Note 2: FFS how to capture UE is activated with multi-Rx operation.
Otherwise
For FR2-1 or the BFD-RS is not using 480 kHz SCS or 960 kHz SCS on FR2-2, the UE is not expected to transmit PUCCH, PUSCH or SRS or receive PDCCH, PDSCH or CSI-RS for tracking or CSI-RS for CQI on BFD-RS resource symbols to be measured for beam failure detection.
For FR2-2 and the BFD-RS is using 480 kHz SCS or 960 kHz SCS, the UE is not expected to transmit PUCCH, PUSCH or SRS or receive PDCCH, PDSCH or CSI-RS for tracking or CSI-RS for CQI on BFD-RS resource symbols to be measured for beam failure detection, and on one data symbol before each BFD-RS symbol to be measured and one data symbol after each BFD-RS symbol to be measured.

When intra-band carrier aggregation in FR2 is performed, the scheduling restrictions on FR2 serving PCell or PSCell apply to all serving cells in the same band on the symbols that fully or partially overlap with restricted symbols.

When inter-band carrier aggregation in FR2 is performed, there are no scheduling restrictions on FR2 serving cells in the bands due to beam failure detection performed on FR2 serving cell(s) in different band(s), provided that UE is capable of independent beam management on this FR2 band pair. Additionally, there is no scheduling restriction if the UE is configured with different numerology between SSB on one FR2 band and data on the other FR2 band provided the UE is configured for IBM operation for the band pair.

For FR2, if following conditions are met,
UE has been notified about system information update through paging,
The gap between UE's reception of PDCCH that UE monitors in the Type2-PDCCH CSS set and that notifies system information update, and the PDCCH that UE monitors in the Type0-PDCCH CSS set, is greater than 2 slots,

For the SSB and CORESET for RMSI scheduling multiplexing patterns 3, UE is expected to receive the PDCCH that UE monitors in the Type0-PDCCH CSS set, and the corresponding PDSCH, on SSB symbols to be measured for BFD measurement; and

For the SSB and CORESET for RMSI scheduling multiplexing patterns 2, UE is expected to receive PDSCH that corresponds to the PDCCH that UE monitors in the Type0-PDCCH CSS set, on SSB symbols to be measured for BFD measurement.

### 8.18.8 Scheduling Availability of UE During TRP Specific Beam Failure Detection

### 8.18.8.3 Scheduling Availability of UE Performing TRP Specific Beam Failure Detection on FR2

The following scheduling restriction applies due to TRP specific beam failure detection.
For the case where no RSs are provided for BFD, or when CSI-RS is configured for BFD is explicitly configured and is type-D QCLed with active TCI state for PDCCH or PDSCH, and the CSI-RS is not in a CSI-RS resource set with repetition ON, or
For FR2-1, for PCell, for UE supporting [TBD —multi-rx capability], if CSI-RS for BFD and the other CSI-RS for tracking or for CQI in the same or overlapping OFDM symbol are configured with different QCL-TypeD in the PCell and the following conditions apply:
The CSI-RS is not in a CSI-RS resource set with repetition ON.
The CSI-RS has same QCL source as the active TCI state of one of the PDSCHs and has different QCL-TypeD from the other PDSCH.
The CSI-RS and both of the PDSCHs are on the same OFDM symbol(s).
[FFS: The CSI-RS and only one of the PDSCHs with different QCLed typeD are on the same OFDM symbol(s)]
Resources of the active TCI states for the two PDSCHs have been reported as a resource group in Rel-17 group-based RSRP report.
[FFS how to capture UE is activated with multi-Rx operation]
There are no scheduling restrictions due to TRP specific beam failure detection performed based on the CSI-RS.
Otherwise
The UE is not expected to transmit PUCCH, PUSCH or SRS or receive PDCCH, PDSCH or CSI-RS for tracking or CSI-RS for CQI on BFD-RS resource symbols to be measured for TRP specific beam failure detection.

When intra-band carrier aggregation in FR2 is performed, the scheduling restrictions on FR2 serving PCell or PSCell apply to all serving cells in the same band on the symbols that fully or partially overlap with restricted symbols.

When inter-band carrier aggregation in FR2 is performed, there are no scheduling restrictions on FR2 serving cells in the bands due to beam failure detection performed on FR2 serving cell(s) in different band(s), provided that UE is capable of independent beam management on this FR2 band pair. Additionally, there is no scheduling restriction if the UE is configured with different numerology between SSB on one FR2 band and data on the other FR2 band provided the UE is configured for IBM operation for the band pair.

For FR2, if following conditions are met,
UE has been notified about system information update through paging,
The gap between UE's reception of PDCCH that UE monitors in the Type2-PDCCH CSS set and that notifies system information update, and the PDCCH that UE monitors in the Type0-PDCCH CSS set, is greater than 2 slots,

For the SSB and CORESET for RMSI scheduling multiplexing patterns 3, UE is expected to receive the PDCCH that UE monitors in the Type0-PDCCH CSS set, and the corresponding PDSCH, on SSB symbols to be measured for BFD measurement; and

For the SSB and CORESET for RMSI scheduling multiplexing patterns 2, UE is expected to receive PDSCH that corresponds to the PDCCH that UE monitors in the Type0-PDCCH CSS set, on SSB symbols to be measured for BFD measurement.

Other sections of 3GPP TS 38.133 may also enumerate scheduling restrictions and/or measurement restrictions as described herein. Embodiments are not limited to these examples.

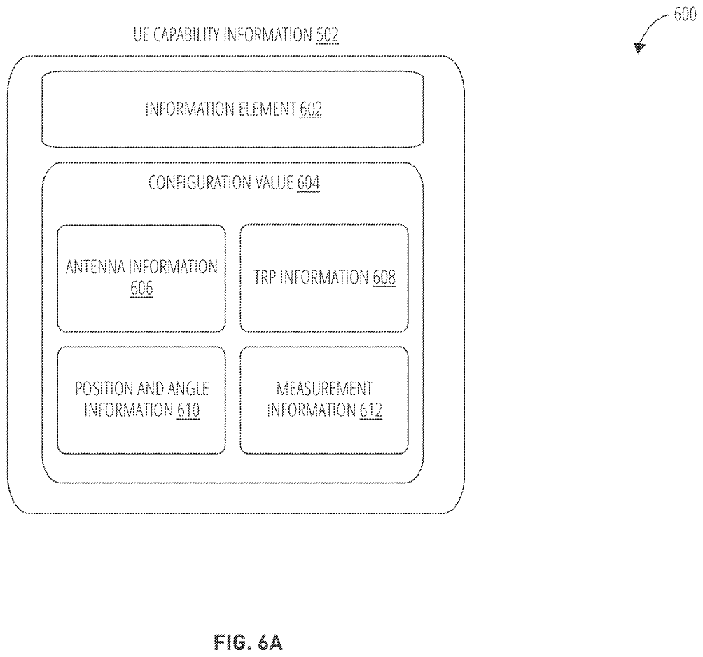

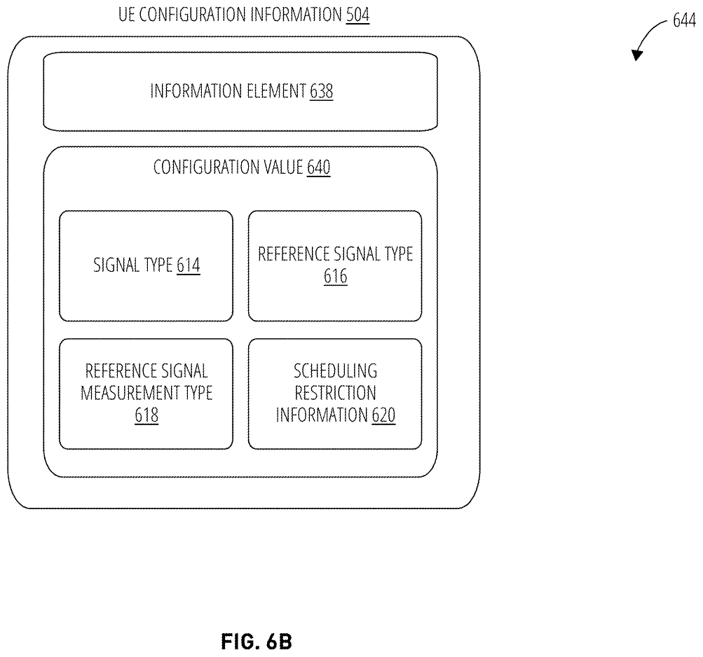

FIG. 6A illustrates a more detailed view of a data schema 600 or messaging format suitable for communicating the UE capability information 502. As depicted in FIG. 6A, the UE 202 may communicate UE capability information 502 including measurement information 512 and/or the simultaneous reception information 514 in messages defined in accordance with one or more 3GPP standards, such as 3GPP TS 38.133 Standards, for example.

The UE capability information 502 may be carried by a network message comprising an information element 602. Examples of network messages and/or information element 602 may include without limitation any network messages, such as 3GPP Release 17 or Release 18 defined messages and/or information elements. Examples of configuration value 604 may include without limitation antenna information 606, TRP information 608, a position and angle information 610, and measurement information 612. Each of the antenna information 606, TRP information 608, position and angle information 610 and measurement information 612 may comply with corresponding values defined in 3GPP 38.133 or 38.331 Standards. Embodiments are not limited to these examples.

FIG. 6B illustrates a more detailed view of a data schema 644 or messaging format suitable for communicating the UE configuration information 504. As depicted in FIG. 6B, the base station, such as the gNB 204, may communicate UE configuration information 504 including measurement information 512 and/or the simultaneous reception information 514 in messages defined in accordance with one or more 3GPP standards, such as 3GPP TS 38.133 Standards, for example.

The UE configuration information 504 may be carried by a network message comprising an information element 638. Examples of network messages and/or information element 638 may include without limitation any network messages, such as 3GPP Release 17 or Release 18 defined messages and/or information elements. Examples of configuration value 640 may include without limitation signal type 614, reference signal type 616, reference signal measurement type 618, and scheduling restriction information 620. Each of the antenna signal type 614, reference signal type 616, reference signal measurement type 618, and scheduling restriction information 620 may comply with corresponding values defined in 3GPP 38.133 or 38.331 Standards. Embodiments are not limited to these examples.

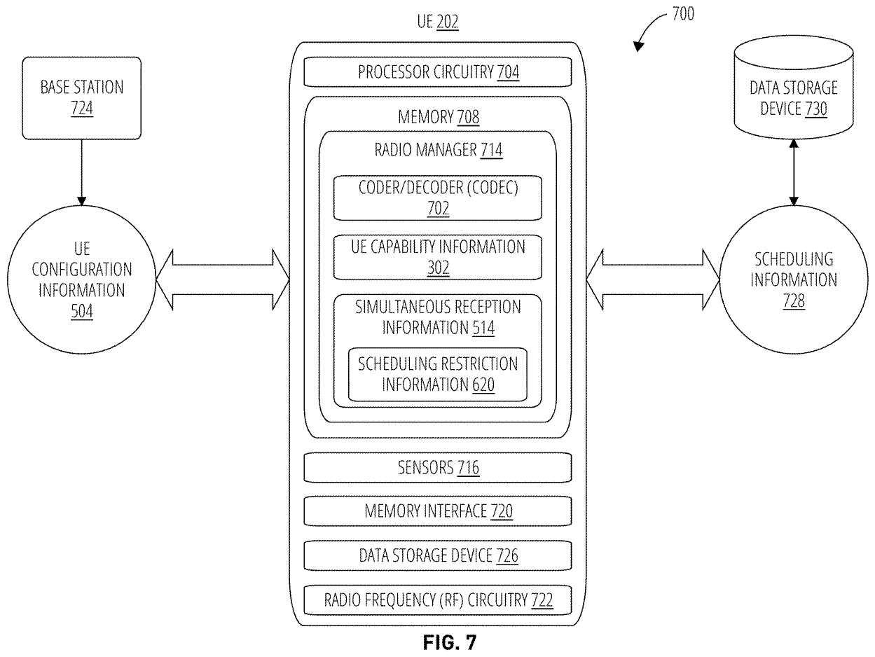

FIG. 7 illustrates an apparatus 700 suitable for implementation as a UE 202 in the wireless communications system 100. As previously discussed, the UE 202 may take measurements and actions based on one or more measurement criteria as defined by the 3GPP TS 38.133 Standards, the 3GPP TS 38.331 Standards, or other 3GPP standards or non-3GPP standards. Embodiments are not limited in this context.

As depicted in FIG. 7, the apparatus 700 may comprise a processor circuitry 704, a memory 708 with a radio manager 714, one or more sensors 716, a memory interface 720, a data storage device 726, and radio-frequency (RF) circuitry 722. Examples of sensors 716 may include sensors capable of collecting geospatial data associated with the UE 202 using any number or type of suitable sensors and associated software and algorithms, such as a GPS system, a gyroscope sensor, an accelerometer, a magnetometer, a barometer, a camera, a light detection and ranging (LIDAR) sensor, a radio detection and ranging (RADAR) sensor, a proximity sensor, and so forth. Embodiments are not limited to these examples. The apparatus 700 may optionally include a set of platform components (not shown) suitable for a UE 102a, such as input/output devices, memory controllers, different memory types, network interfaces, hardware ports, and so forth.

The apparatus 700 for the UE 202 may receive UE configuration information 504 from a base station 724 via the RF circuitry 722. The base station 724 may comprise a RAN node 1 308 or a RAN node 2 310 implemented as, for example, a NodeB or an eNodeB such as gNB 204 of the wireless communications system 100 or the wireless communications system 200. The base station 724 may also transmit reference signals to the UE 202. For example, the reference signals may include any reference signals communicated between the UE 202 and the RAN node 1 308 and/or the RAN node 2 310, respectively. In this case, reference signals may comprise, for example, reference signals for SS-RSRP measurement, reference signals for SS-RSRQ measurement, BFD reference signals, RLM reference signals, SDT reference signals, or any other signals suitable for measurement or relaxed measurement in the wireless communications system 100 or the wireless communications system 200.

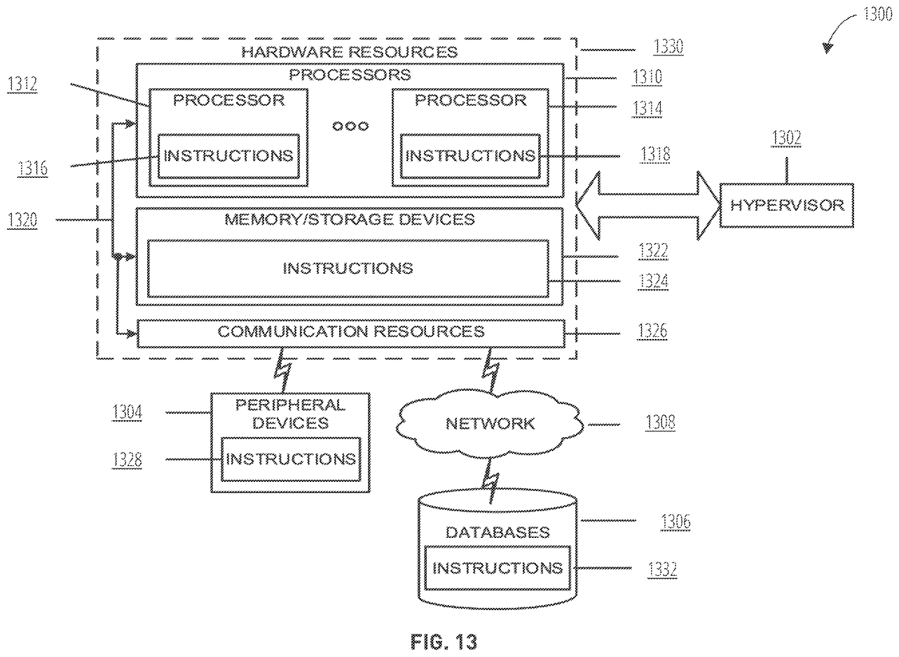

The apparatus 700 for the UE 202 may include the memory interface 720. The memory interface 720 may be arranged to send or receive, to or from a data storage device 726 or a data storage device 730, scheduling information 728 for a 5G or 6G NR system. The data storage device 730 may be located external to the UE 202 (off-device) and the data storage device 726 may be located internal to the UE 202 (on-device). When the data storage device 726 is implemented on-device, the data storage device 726 may comprise volatile or non-volatile memory, as described in more detail with reference to FIG. 13.

The apparatus 700 may include processor circuitry 704 communicatively coupled to the memory 708, the memory interface 720, the data storage device 726 and the RF circuitry 722. The memory 708 may store instructions that when executed by the processor circuitry 704 may implement or manage a radio manager 714 for the UE 202. The radio manager 714 may include a coder/decoder (codec), such as the codec 702. The codec 702 may encode and decode messages to and from the base station 724. The radio manager 714 may further include or have access to the UE capability information 302 for reporting to the base station 724. The radio manager 714 may further include or have access to the simultaneous reception information 514 for the UE 202, the simultaneous reception information 514 to include scheduling restriction information 620 to restrict or make conditional simultaneous reception operations for the UE 202. Alternatively, the radio manager 714 may be implemented in a controller for the RF circuitry 722, such as a media access control (MAC) or baseband controller.

In one embodiment, for example, the simultaneous reception information 514 may refer to the UE 202 receiving two or more signals in a same or overlapping orthogonal frequency division multiplexed (OFDM) symbols from one or more transmission sources, such as RAN node 1 308 and/or RAN node 2 310. For instance, the overlapping signals may comprise various combinations of a data signal and a reference signal. In this case, simultaneous reception may refer to the UE 202 receiving multiple data signals, multiple reference signals, or a combination of data signals and reference signals. Embodiments are not limited to these types of signals or signal permutations.

In one embodiment, for example, the scheduling restriction information 620 may refer to a set of defined conditions that should be, or must be, implemented by the UE 202 during simultaneous reception operations by the UE 202. A network scheduler 218 may determine one or more scheduling restrictions for the UE 202 based on a number of factors, such as UE capabilities, overall network operations, or available network resources at a given moment in time. For example, a scheduling restriction may limit or restrict the UE 202 from performing certain operations during simultaneous reception operations by the UE 202, such as receiving signals from certain transmission sources (e.g., base stations), measuring certain signals or frequency ranges, performing radio link monitoring, and so forth. Stated another way, a scheduling restriction may define availability of the UE 202 to perform certain operations during simultaneous reception operations by the UE 202. Examples of a scheduling restriction may comprise scheduling availability of the UE 202 during radio link monitoring on frequency range 1 (FR1) or frequency range 2 (FR2), scheduling availability of the UE 202 performing beam failure detection on FRI or FR2, scheduling availability of the UE 202 performing TRP specific beam failure detection on FR1 or FR2, and so forth. Embodiments are not limited to these examples or a given set of conditions defined for the UE 202, and the conditions may vary based on different implementations.

In one embodiment, for example, the scheduling restriction information 620 defines a set of conditions for the UE to simultaneously receive or measure multiple signals during simultaneous reception operations by the UE 202, the multiple signals to comprise multiple data signals, multiple reference signals, or a combination of a data signal and a reference signal.

In operation, the codec 702 may encode a first message for the base station 724 with UE capability information 502, the UE capability information 502 to comprise a first information element 602 with a first configuration value 604 to represent antenna information 606 for the UE 202 and a second information element 602 with a second configuration value 604 to represent position and angle information 610 for the UE 202. The codec 702 may decode a second message from the base station 724 with UE configuration information 504, the UE configuration information 504 to comprise a first information element 638 with a first configuration value 640 to represent simultaneous reception information 514 for the UE 202, the simultaneous reception information 514 to include scheduling restriction information 620 for the UE 202. The radio manager 714 may determine whether the simultaneous reception information 514 and the scheduling restriction information 620 indicates the UE 202 can support simultaneous reception of signals from one or more TRPs, such as TRP 1 322 and/or TRP 2 324, for example.

The UE 202 may also include the radio manager 714 to cause the UE 202 to perform simultaneous reception of signals from the one or more TRPs, such as TRP 1 322 and/or TRP 2 324, in accordance with the scheduling restriction information 620 when the radio manager 714 determines the UE 202 can support simultaneous reception based on the UE configuration information 504.

The codec 702 may encode a third message for the base station 724 with updated UE capability information 502, the updated UE capability information 502 to comprise a third information element 602 with a third configuration value 604 to represent updated position and angle information 610 for the UE 202. For example, assume the original position and angle information 610 for the UE 202 indicates a position A and angle A, while the updated position and angle information 610 for the UE 202 indicates a position B and angle B due to the movement of the UE 202 or re-orientation of the UE 202.

The codec 702 may decode a fourth message from the base station 724 with updated UE configuration information 504, the updated UE configuration information 504 to comprise a third information element 638 with a third configuration value 640 to represent updated simultaneous reception information 514 for the UE 202, the updated simultaneous reception information 514 to include updated scheduling restriction information 620 for the UE 202. For example, assume the updated position and angle information 610 indicates a position B and angle B. The base station 724 will re-generate the UE configuration information 504 based on the position B and angle of the UE 202, which could mean different scheduling restriction information 620 for the UE 202.

The codec 702 may encode the first message to further include a second information element 602 with a second configuration value 604 to represent UE capability information 502, the second configuration value 604 to represent TRP information 608 for the TRPs, such as the TRP 1 322 and/or the TRP 2 324, detected by the UE 202 or measurement information 512 to represent measurement capabilities for the UE 202 or actual measurements made by the UE 202 on measurement objects (MOs).

The codec 702 may decode the second message to include a second information element 638 with a second configuration value 640 to represent simultaneous reception information 514 for the UE 202, the second configuration value 640 to comprise a signal type 614, a reference signal type 616, or a reference signal measurement type 618, in addition to the scheduling restriction information 620.

The UE 202 also includes RF circuitry 722 coupled to the processor circuitry 704, the RF circuitry 722 to transmit the first message with the UE capability information 502 over RF signals to the base station 724, and receive the second message with the simultaneous reception information 514 for the UE 202 over RF signals from the base station 724.

As previously discussed, the UE 202 may perform simultaneous reception operations and actions based on one or more scheduling restrictions as defined by the 3GPP TS 38.133 Standards, the 3GPP TS 38.331 Standards, or other 3GPP standards or non-3GPP standards.

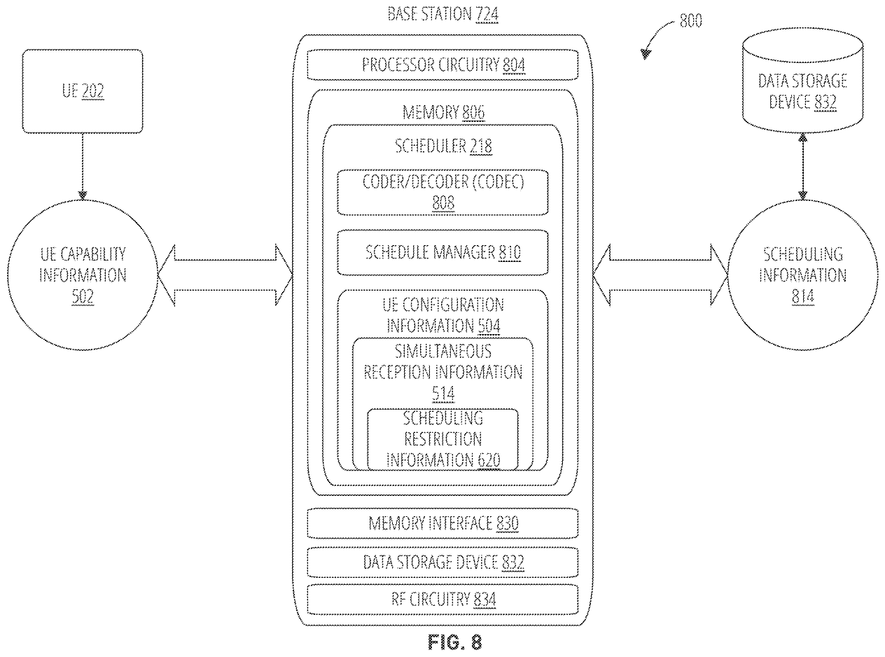

FIG. 8 illustrates an apparatus 800 suitable for implementation as a base station 724 in the wireless communications system 100 and/or the wireless communications system 200. The base station 724 is an example of the gNB 204. As previously discussed, the base station 724 may receive UE capability information 502 from the UE 202. The base station 724 may send UE configuration information 504 to the UE 202 based on the received UE capability information 502.

As depicted in FIG. 8, the apparatus 800 may comprise a processor circuitry 804, a memory 806 with a scheduler 218, a memory interface 830, a data storage device 832, and RF circuitry 834. The scheduler 218 may comprise a codec 808 and a schedule manager 810. The scheduler 218 may generate the UE configuration information 504, including the simultaneous reception information 514 with the scheduling restriction information 620. The apparatus 800 may optionally include a set of platform components (not shown) suitable for a UE 202, such as input/output devices, memory controllers, different memory types, network interfaces, hardware ports, and so forth.

In one embodiment, the apparatus 800 may be implemented for the base station 724. The base station 724 includes a memory interface 830 to send or receive, to or from a data storage device 832, scheduling information 814 for a wireless communications system 100 or a wireless communications system 200. The base station 724 also includes processor circuitry 804 communicatively coupled to the memory interface 830, the processor circuitry 804 to execute instructions for the scheduler 218, to cause the codec 808 to decode a message from the UE 202 with UE capability information 502. The UE capability information 502 may comprise a first information element 602 with a first configuration value 604 to represent antenna information 606 for the UE 202 and a second information element 602 with a second configuration value 604 to represent position and angle information 610 for the UE 202. The schedule manager 810 may determine whether the antenna information 606 and the position and angle information 610 indicates the UE 202 is capable of supporting simultaneous reception operations. The schedule manager 810 generates simultaneous reception information 514 for the UE 202 when the schedule manager 810 determines the antenna information 606 and the position and angle information 610 indicates the UE 202 supports simultaneous reception. The simultaneous reception information 514 may include scheduling restriction information 620 for the UE 202 as previously described. The codec 808 may encode a message with the simultaneous reception information 514 for the UE 202, for transmission from the base station 724 to the UE 202.

The antenna information 606 includes, for example, a number of antenna modules, such as {antenna module 1 342, antenna module 2 344}, and a number of panels for each of the antenna modules, such as {panel 1 316, panel 2 318, panel 1 402, panel 2 404}, for the UE 202.

The message may include the position and angle information 610 to include an angle of the UE 202 relative to one or more base stations 724, such as angle A, angle B, angle C, and so forth.

The message may include the simultaneous reception information 514 for the UE 202 to include a signal type 614, a reference signal type 616, or a RS reference signal measurement type 618, in addition to the scheduling restriction information 620.

In one embodiment, the scheduling restriction information 620 may represent scheduling availability of the UE 202 for performing radio link monitoring on frequency range 1 (FR1) or frequency range 2 (FR2), as defined in the 3GPP 38.133 Standards, Section 8.1.7, for example.

In one embodiment, the scheduling restriction information 620 may represent scheduling availability of the UE 202 for performing beam failure detection on frequency range 1 (FR1) or frequency range 2 (FR2), as defined in the 3GPP 38.133 Standards, Section 8.5.7, for example.

In one embodiment, the scheduling restriction information 620 may represent scheduling availability of the UE 202 for performing TRP specific beam failure detection on frequency range 1 (FR1) or frequency range 2 (FR2), as defined in the 3GPP 38.133 Standards, Section 8.18.8, for example

The base station 724 may also include RF circuitry 834 coupled to the processor circuitry 804, the RF circuitry 834 to transmit a message with the simultaneous reception information 514 for the UE 202 over RF signals, and to receive a message with the UE capability information 502 from the UE 202 over RF signals.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

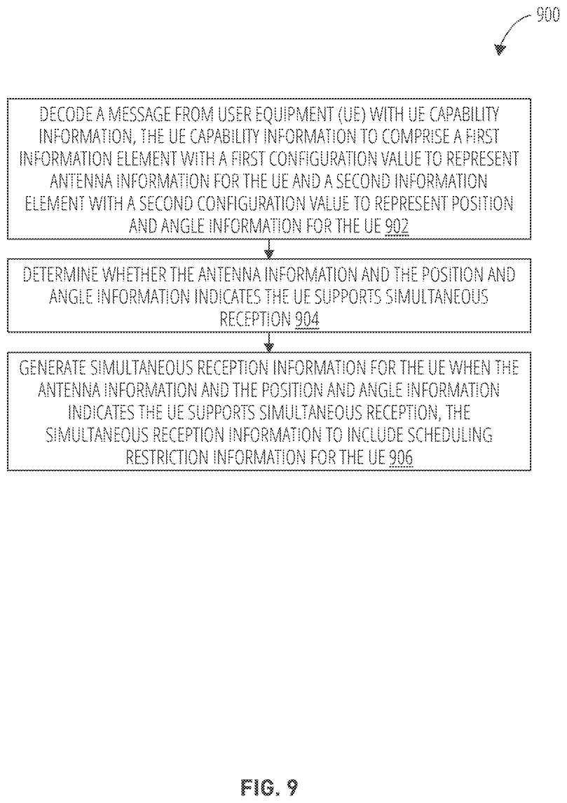

FIG. 9 illustrates an embodiment of a logic flow 900. The logic flow 900 may be representative of some or all of the operations executed by one or more embodiments described herein. For example, the logic flow 900 may include some or all of the operations performed by devices or entities within the wireless communications system 100 and/or the wireless communications system 200, such as the base station 724 and/or the gNB 204. More particularly, the logic flow 900 illustrates a use case where the base station 724 may use the UE capability information 502 carried by the information element 602 to perform scheduling of simultaneous reception operations performed by the UE 202. Embodiments are not limited in this context.

In block 902, logic flow 900 decodes a message from user equipment (UE) with UE capability information, the UE capability information to comprise a first information element with a first configuration value to represent antenna information for the UE and a second information element with a second configuration value to represent position and angle information for the UE. In block 904, logic flow 900 determines whether the antenna information and the position and angle information indicates the UE supports simultaneous reception. In block 906, logic flow 900 generates simultaneous reception information for the UE when the antenna information and the position and angle information indicates the UE supports simultaneous reception, the simultaneous reception information to include scheduling restriction information for the UE.

By way of example, with reference to the base station 724, the codec 808 decodes a message from UE 202 with UE capability information 502, the UE capability information 502 to comprise a first information element 602 with a first configuration value 604 to represent antenna information 606 for the UE 202 and a second information element 602 with a second configuration value 604 to represent position and angle information 610 for the UE 202. The schedule manager 810 of the base station 724 determines whether the antenna information 606 and the position and angle information 610 indicates the UE 202 supports simultaneous reception. The schedule manager 810 generates simultaneous reception information 514 for the UE 202 when the antenna information 606 and the position and angle information 610 indicates the UE 202 is capable of supporting simultaneous reception, the simultaneous reception information 514 to include scheduling restriction information 620 for the UE.

In one embodiment, the scheduling restriction information 620 may represent scheduling availability of the UE 202 for performing radio link monitoring on frequency range 1 (FR1) or frequency range 2 (FR2), as defined in the 3GPP 38.133 Standards, Section 8.1.7, for example.

In one embodiment, the scheduling restriction information 620 may represent scheduling availability of the UE 202 for performing beam failure detection on frequency range 1 (FR1) or frequency range 2 (FR2), as defined in the 3GPP 38.133 Standards, Section 8.5.7, for example.

In one embodiment, the scheduling restriction information 620 may represent scheduling availability of the UE 202 for performing TRP specific beam failure detection on frequency range 1 (FR1) or frequency range 2 (FR2), as defined in the 3GPP 38.133 Standards, Section 8.18.8, for example.

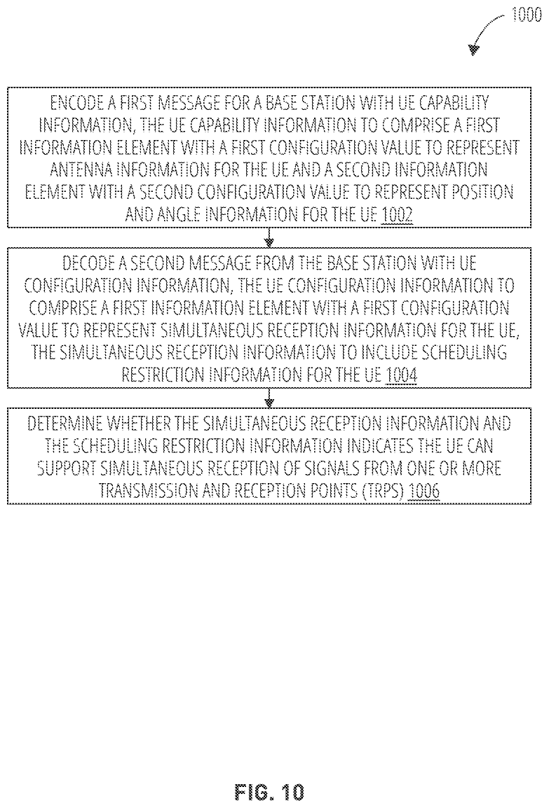

FIG. 10 illustrates an embodiment of a logic flow 1000. The logic flow 1000 may be representative of some or all of the operations executed by one or more embodiments described herein. For example, the logic flow 1000 may include some or all of the operations performed by devices or entities within the wireless communications system 100 and/or the wireless communications system 200, such as the UE 202. More particularly, the logic flow 1000 illustrates a use case where the UE 202 may encode the UE capability information 502 carried by the information element 602 to perform scheduling of simultaneous reception operations by the base station 724, and decode the UE configuration information 504 carried by the information element 638 to perform simultaneous reception operations by the UE 202. Embodiments are not limited in this context.

In block 1002, logic flow 1000 encodes a first message for a base station with UE capability information, the UE capability information to comprise a first information element with a first configuration value to represent antenna information for the UE and a second information element with a second configuration value to represent position and angle information for the UE. In block 1004, logic flow 1000 decodes a second message from the base station with UE configuration information, the UE configuration information to comprise a first information element with a first configuration value to represent simultaneous reception information for the UE, the simultaneous reception information to include scheduling restriction information for the UE. In block 1006, logic flow 1000 determines whether the simultaneous reception information and the scheduling restriction information indicates the UE can support simultaneous reception of signals from one or more transmission and reception points (TRPs).

By way of example, with reference to UE 202, the codec 702 encodes a first message for a base station 724 with UE capability information 502, the UE capability information 502 to comprise a first information element 602 with a first configuration value 604 to represent antenna information 606 for the UE 202 and a second information element 602 with a second configuration value 604 to represent position and angle information 610 for the UE 202. The codec 702 decodes a second message from the base station 724 with UE configuration information 504, the UE configuration information 504 to comprise a first information element 638 with a first configuration value 640 to represent simultaneous reception information 514 for the UE 202, the simultaneous reception information 514 to include scheduling restriction information 620 for the UE 202. The radio manager 714 determines whether the simultaneous reception information 514 and the scheduling restriction information 620 indicates the UE 202 can support simultaneous reception of signals from one or more TRPs, such as the TRP 1 322 and/or the TRP 2 324.

In one embodiment, the scheduling restriction information 620 may represent scheduling availability of the UE 202 for performing radio link monitoring on frequency range 1 (FR1) or frequency range 2 (FR2), as defined in the 3GPP 38.133 Standards, Section 8.1.7, for example.

In one embodiment, the scheduling restriction information 620 may represent scheduling availability of the UE 202 for performing beam failure detection on frequency range 1 (FR1) or frequency range 2 (FR2), as defined in the 3GPP 38.133 Standards, Section 8.5.7, for example.

In one embodiment, the scheduling restriction information 620 may represent scheduling availability of the UE 202 for performing TRP specific beam failure detection on frequency range 1 (FR1) or frequency range 2 (FR2), as defined in the 3GPP 38.133 Standards, Section 8.18.8, for example

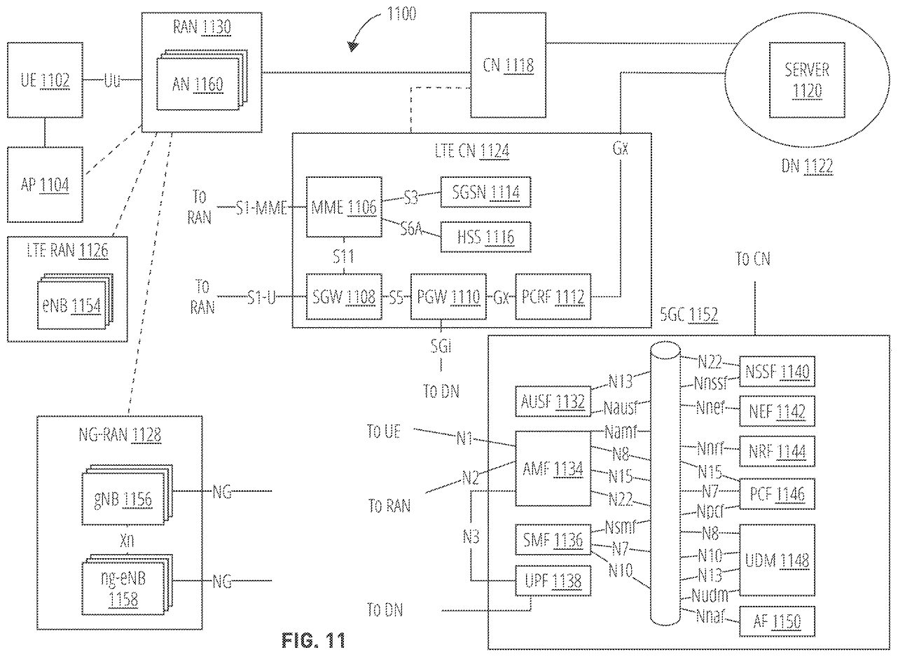

FIGS. 11-14 illustrate various systems, devices and components that may implement aspects of disclosed embodiments. The systems, devices, and components may be the same, or similar to, the systems, device and components described with reference to FIG. 1 through FIG. 10.

FIG. 11 illustrates a network 1100 in accordance with various embodiments. The network 1100 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1100 may include a UE 1102, which may include any mobile or non-mobile computing device designed to communicate with a RAN 1130 via an over-the-air connection. The UE 1 102 may be communicatively coupled with the RAN 1130 by a Uu interface. The UE 1102 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1100 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1102 may additionally communicate with an AP 1104 via an over-the-air connection. The AP 1104 may manage a WLAN connection, which may serve to offload some/all network traffic from the RAN 1130. The connection between the UE 1102 and the AP 1104 may be consistent with any IEEE 1102.11 protocol, wherein the AP 1104 could be a wireless fidelity (Wi-Fi®) router. In some embodiments, the UE 1102, RAN 1130, and AP 1104 may utilize cellular-WLAN aggregation (for example, LWA/LWIP). Cellular-WLAN aggregation may involve the UE 1102 being configured by the RAN 1130 to utilize both cellular radio resources and WLAN resources.

The RAN 1130 may include one or more access nodes, for example, AN 1160. AN 1160 may terminate air-interface protocols for the UE 1102 by providing access stratum protocols including RRC, PDCP, RLC, MAC, and L1 protocols. In this manner, the AN 1160 may enable data/voice connectivity between CN 1118 and the UE 1102. In some embodiments, the AN 1160 may be implemented in a discrete device or as one or more software entities running on server computers as part of, for example, a virtual network, which may be referred to as a CRAN or virtual baseband unit pool. The AN 1160 be referred to as a BS, gNB, RAN node, eNB, ng-eNB, NodeB, RSU, TRxP, TRP, etc. The AN 1160 may be a macrocell base station or a low power base station for providing femtocells, picocells or other like cells having smaller coverage areas, smaller user capacity, or higher bandwidth compared to macrocells.

In embodiments in which the RAN 1130 includes a plurality of ANs, they may be coupled with one another via an X2 interface (if the RAN 1130 is an LTE RAN) or an Xn interface (if the RAN 1130 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1130 may each manage one or more cells, cell groups, component carriers, etc. to provide the UE 1102 with an air interface for network access. The UE 1102 may be simultaneously connected with a plurality of cells provided by the same or different ANs of the RAN 1130. For example, the UE 1102 and RAN 1130 may use carrier aggregation to allow the UE 1102 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1130 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1102 or AN 1160 may be or act as an RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1130 may be an LTE RAN 1126 with eNBs, for example, eNB 1154. The LTE RAN 1126 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1130 may be an NG-RAN 1128 with gNBs, for example, gNB 1156, or ng-eNBs, for example, ng-eNB 1158. The gNB 1156 may connect with 5G-enabled UEs using a 5G NR interface. The gNB 1156 may connect with a 5G core through an NG interface, which may include an N2 interface or an N3 interface. The ng-eNB 1158 may also connect with the 5G core through an NG interface, but may connect with a UE via an LTE air interface. The gNB 1156 and the ng-eNB 1158 may connect with each other over an Xn interface.

In some embodiments, the NG interface may be split into two parts, an NG user plane (NG-U) interface, which carries traffic data between the nodes of the NG-RAN 1128 and a UPF 1138 (e.g., N3 interface), and an NG control plane (NG-C) interface, which is a signaling interface between the nodes of the NG-RAN 1128 and an AMF 1134 (e.g., N2 interface).

The NG-RAN 1128 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1102 can be configured with multiple BWPs where each BWP configuration has a different SCS. When a BWP change is indicated to the UE 1102, the SCS of the transmission is changed as well. Another use case example of BWP is related to power saving. In particular, multiple BWPs can be configured for the UE 1102 with different amount of frequency resources (for example, PRBs) to support data transmission under different traffic loading scenarios. A BWP containing a smaller number of PRBs can be used for data transmission with small traffic load while allowing power saving at the UE 1102 and in some cases at the gNB 1156. A BWP containing a larger number of PRBs can be used for scenarios with higher traffic load.

The RAN 1130 is communicatively coupled to CN 1118 that includes network elements to provide various functions to support data and telecommunications services to customers/subscribers (for example, users of UE 1102). The components of the CN 1118 may be implemented in one physical node or separate physical nodes. In some embodiments, NFV may be utilized to virtualize any or all of the functions provided by the network elements of the CN 1118 onto physical compute/storage resources in servers, switches, etc. A logical instantiation of the CN 1118 may be referred to as a network slice, and a logical instantiation of a portion of the CN 1118 may be referred to as a network sub-slice.

In some embodiments, the CN 1118 may be an LTE CN 1124, which may also be referred to as an EPC. The LTE CN 1124 may include MME 1106, SGW 1108, SGSN 1114, HSS 1116, PGW 1110, and PCRF 1112 coupled with one another over interfaces (or “reference points”) as shown. Functions of the elements of the LTE CN 1124 may be briefly introduced as follows.

The MME 1106 may implement mobility management functions to track a current location of the UE 1102 to facilitate paging, bearer activation/deactivation, handovers, gateway selection, authentication, etc.

The SGW 1108 may terminate an S1 interface toward the RAN and route data packets between the RAN and the LTE CN 1124. The SGW 1108 may be a local mobility anchor point for inter-RAN node handovers and also may provide an anchor for inter-3GPP mobility. Other responsibilities may include lawful intercept, charging, and some policy enforcement.

The SGSN 1114 may track a location of the UE 1102 and perform security functions and access control. In addition, the SGSN 1114 may perform inter-EPC node signaling for mobility between different RAT networks; PDN and S-GW selection as specified by MME 1106; MME selection for handovers; etc. The S3 reference point between the MME 1106 and the SGSN 1114 may enable user and bearer information exchange for inter-3GPP access network mobility in idle/active states.

The HSS 1116 may include a database for network users, including subscription-related information to support the network entities' handling of communication sessions. The HSS 1116 can provide support for routing/roaming, authentication, authorization, naming/addressing resolution, location dependencies, etc. An S6a reference point between the HSS 1116 and the MME 1106 may enable transfer of subscription and authentication data for authenticating/authorizing user access to the LTE CN 1118.

The PGW 1110 may terminate an SGi interface toward a data network (DN) 1122 that may include an application/content server 1120. The PGW 1110 may route data packets between the LTE CN 1124 and the data network 1122. The PGW 1110 may be coupled with the SGW 1108 by an S5 reference point to facilitate user plane tunneling and tunnel management. The PGW 1110 may further include a node for policy enforcement and charging data collection (for example, PCEF). Additionally, the SGi reference point between the PGW 1110 and the data network 1122 may be an operator external public, a private PDN, or an intra-operator packet data network, for example, for provision of IMS services. The PGW 1110 may be coupled with a PCRF 1112 via a Gx reference point.

The PCRF 1112 is the policy and charging control element of the LTE CN 1124. The PCRF 1112 may be communicatively coupled to the app/content server 1120 to determine appropriate QoS and charging parameters for service flows. The PCRF 1110 may provision associated rules into a PCEF (via Gx reference point) with appropriate TFT and QCI.

In some embodiments, the CN 1118 may be a 5GC 1152. The 5GC 1152 may include an AUSF 1132, AMF 1134, SMF 1136, UPF 1138, NSSF 1140, NEF 1142, NRF 1144, PCF 1146, UDM 1148, and AF 1150 coupled with one another over interfaces (or “reference points”) as shown. Functions of the elements of the 5GC 1152 may be briefly introduced as follows.

The AUSF 1132 may store data for authentication of UE 1102 and handle authentication-related functionality. The AUSF 1132 may facilitate a common authentication framework for various access types. In addition to communicating with other elements of the 5GC 1152 over reference points as shown, the AUSF 1132 may exhibit an Nausf service-based interface.

The AMF 1134 may allow other functions of the 5GC 1152 to communicate with the UE 1102 and the RAN 1130 and to subscribe to notifications about mobility events with respect to the UE 1102. The AMF 1134 may be responsible for registration management (for example, for registering UE 1102), connection management, reachability management, mobility management, lawful interception of AMF-related events, and access authentication and authorization. The AMF 1134 may provide transport for SM messages between the UE 1102 and the SMF 1136, and act as a transparent proxy for routing SM messages. AMF 1134 may also provide transport for SMS messages between UE 1102 and an SMSF. AMF 1134 may interact with the AUSF 1132 and the UE 1102 to perform various security anchor and context management functions. Furthermore, AMF 1134 may be a termination point of a RAN CP interface, which may include or be an N2 reference point between the RAN 1130 and the AMF 1134; and the AMF 1134 may be a termination point of NAS (N1) signaling, and perform NAS ciphering and integrity protection. AMF 1134 may also support NAS signaling with the UE 1102 over an N3 IWF interface.

The SMF 1136 may be responsible for SM (for example, session establishment, tunnel management between UPF 1138 and AN 1160); UE IP address allocation and management (including optional authorization); selection and control of UP function; configuring traffic steering at UPF 1138 to route traffic to proper destination; termination of interfaces toward policy control functions; controlling part of policy enforcement, charging, and QoS; lawful intercept (for SM events and interface to L1 system); termination of SM parts of NAS messages; downlink data notification; initiating AN specific SM information, sent via AMF 1134 over N2 to AN 1160; and determining SSC mode of a session. SM may refer to management of a PDU session, and a PDU session or “session” may refer to a PDU connectivity service that provides or enables the exchange of PDUs between the UE 1102 and the data network 1122.

The UPF 1138 may act as an anchor point for intra-RAT and inter-RAT mobility, an external PDU session point of interconnect to data network 1122, and a branching point to support multi-homed PDU session. The UPF 1138 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1138 may include an uplink classifier to support routing traffic flows to a data network.

The NSSF 1140 may select a set of network slice instances serving the UE 1102. The NSSF 1140 may also determine allowed NSSAI and the mapping to the subscribed S-NSSAIs, if needed. The NSSF 1140 may also determine the AMF set to be used to serve the UE 1102, or a list of candidate AMFs based on a suitable configuration and possibly by querying the NRF 1144. The selection of a set of network slice instances for the UE 1102 may be triggered by the AMF 1134 with which the UE 1102 is registered by interacting with the NSSF 1140, which may lead to a change of AMF. The NSSF 1140 may interact with the AMF 1134 via an N22 reference point; and may communicate with another NSSF in a visited network via an N31 reference point (not shown). Additionally, the NSSF 1140 may exhibit an Nnssf service-based interface.

The NEF 1142 may securely expose services and capabilities provided by 3GPP network functions for third party, internal exposure/re-exposure, AFs (e.g., AF 1150), edge computing or fog computing systems, etc. In such embodiments, the NEF 1142 may authenticate, authorize, or throttle the AFs. NEF 1142 may also translate information exchanged with the AF 1150 and information exchanged with internal network functions. For example, the NEF 1142 may translate between an AF-Service-Identifier and an internal 5GC information. NEF 1142 may also receive information from other NFs based on exposed capabilities of other NFs. This information may be stored at the NEF 1142 as structured data, or at a data storage NF using standardized interfaces. The stored information can then be re-exposed by the NEF 1142 to other NFs and AFs, or used for other purposes such as analytics. Additionally, the NEF 1142 may exhibit an Nnef service-based interface.

The NRF 1144 may support service discovery functions, receive NF discovery requests from NF instances, and provide the information of the discovered NF instances to the NF instances. NRF 1144 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1144 may exhibit the Nnrf service-based interface.

The PCF 1146 may provide policy rules to control plane functions to enforce them, and may also support unified policy framework to govern network behavior. The PCF 1146 may also implement a front end to access subscription information relevant for policy decisions in a UDR of the UDM 1148. In addition to communicating with functions over reference points as shown, the PCF 1146 exhibit an Npcf service-based interface.

The UDM 1148 may handle subscription-related information to support the network entities' handling of communication sessions, and may store subscription data of UE 1102. For example, subscription data may be communicated via an N8 reference point between the UDM 1148 and the AMF 1134. The UDM 1148 may include two parts, an application front end and a UDR. The UDR may store subscription data and policy data for the UDM 1148 and the PCF 1146, and/or structured data for exposure and application data (including PFDs for application detection, application request information for multiple UEs 1102) for the NEF 1142. The Nudr service-based interface may be exhibited by the UDR 221 to allow the UDM 1148, PCF 1146, and NEF 1142 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1148 may exhibit the Nudm service-based interface.

The AF 1150 may provide application influence on traffic routing, provide access to NEF, and interact with the policy framework for policy control.

In some embodiments, the 5GC 1152 may enable edge computing by selecting operator/3^{rd} party services to be geographically close to a point that the UE 1102 is attached to the network. This may reduce latency and load on the network. To provide edge-computing implementations, the 5GC 1152 may select a UPF 1138 close to the UE 1102 and execute traffic steering from the UPF 1138 to data network 1122 via the N6 interface. This may be based on the UE subscription data, UE location, and information provided by the AF 1150. In this way, the AF 1150 may influence UPF (re)selection and traffic routing. Based on operator deployment, when AF 1150 is considered to be a trusted entity, the network operator may permit AF 1150 to interact directly with relevant NFs. Additionally, the AF 1150 may exhibit a Naf service-based interface.

The data network 1122 may represent various network operator services, Internet access, or third party services that may be provided by one or more servers including, for example, application/content server 1120.

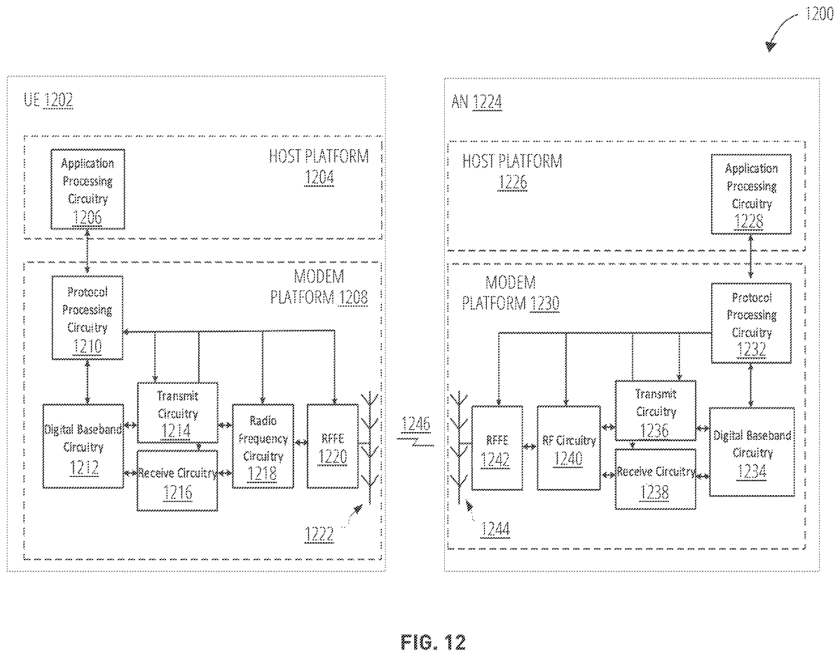

FIG. 12 schematically illustrates a wireless network 1200 in accordance with various embodiments. The wireless network 1200 may include a UE 1202 in wireless communication with an AN 1224. The UE 1202 and AN 1224 may be similar to, and substantially interchangeable with, like-named components described elsewhere herein.

The UE 1202 may be communicatively coupled with the AN 1224 via connection 1246. The connection 1246 is illustrated as an air interface to enable communicative coupling, and can be consistent with cellular communications protocols such as an LTE protocol or a 5G NR protocol operating at mmWave or sub-6 GHz frequencies.

The UE 1202 may include a host platform 1204 coupled with a modem platform 1208. The host platform 1204 may include application processing circuitry 1206, which may be coupled with protocol processing circuitry 1210 of the modem platform 1208. The application processing circuitry 1206 may run various applications for the UE 1202 that source/sink application data. The application processing circuitry 1206 may further implement one or more layer operations to transmit/receive application data to/from a data network. These layer operations may include transport (for example UDP) and Internet (for example, IP) operations

The protocol processing circuitry 1210 may implement one or more of layer operations to facilitate transmission or reception of data over the connection 1246. The layer operations implemented by the protocol processing circuitry 1210 may include, for example, MAC, RLC, PDCP, RRC and NAS operations.

The modem platform 1208 may further include digital baseband circuitry 1212 that may implement one or more layer operations that are “below” layer operations performed by the protocol processing circuitry 1210 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1208 may further include transmit circuitry 1214, receive circuitry 1216, RF circuitry 1218, and RF front end (RFFE) 1220, which may include or connect to one or more antenna panels 1222. Briefly, the transmit circuitry 1214 may include a digital-to-analog converter, mixer, intermediate frequency (IF) components, etc.; the receive circuitry 1216 may include an analog-to-digital converter, mixer, IF components, etc.; the RF circuitry 1218 may include a low-noise amplifier, a power amplifier, power tracking components, etc.; RFFE 1220 may include filters (for example, surface/bulk acoustic wave filters), switches, antenna tuners, beamforming components (for example, phase-array antenna components), etc. The selection and arrangement of the components of the transmit circuitry 1214, receive circuitry 1216, RF circuitry 1218, RFFE 1220, and antenna panels 1222 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1210 may include one or more instances of control circuitry (not shown) to provide control functions for the transmit/receive components.

A UE reception may be established by and via the antenna panels 1222, RFFE 1220, RF circuitry 1218, receive circuitry 1216, digital baseband circuitry 1212, and protocol processing circuitry 1210. In some embodiments, the antenna panels 1222 may receive a transmission from the AN 1224 by receive-beamforming signals received by a plurality of antennas/antenna elements of the one or more antenna panels 1222.

A UE transmission may be established by and via the protocol processing circuitry 1210, digital baseband circuitry 1212, transmit circuitry 1214, RF circuitry 1218, RFFE 1220, and antenna panels 1222. In some embodiments, the transmit components of the UE 1224 may apply a spatial filter to the data to be transmitted to form a transmit beam emitted by the antenna elements of the antenna panels 1222.

Similar to the UE 1202, the AN 1224 may include a host platform 1226 coupled with a modem platform 1230. The host platform 1226 may include application processing circuitry 1228 coupled with protocol processing circuitry 1232 of the modem platform 1230. The modem platform may further include digital baseband circuitry 1234, transmit circuitry 1236, receive circuitry 1238, RF circuitry 1240, RFFE circuitry 1242, and antenna panels 1244. The components of the AN 1224 may be similar to and substantially interchangeable with like-named components of the UE 1202. In addition to performing data transmission/reception as described above, the components of the A 1204 may perform various logical functions that include, for example, RNC functions such as radio bearer management, uplink and downlink dynamic radio resource management, and data packet scheduling.

FIG. 13 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 13 shows a diagrammatic representation of hardware resources 1330 including one or more processors (or processor cores) 1310, one or more memory/storage devices 1322, and one or more communication resources 1326, each of which may be communicatively coupled via a bus 1320 or other interface circuitry. For embodiments where node virtualization (e.g., NFV) is utilized, a hypervisor 1302 may be executed to provide an execution environment for one or more network slices/sub-slices to utilize the hardware resources 1330.

The processors 1310 may include, for example, a processor 1312 and a processor 1314. The processors 1310 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1322 may include main memory, disk storage, or any suitable combination thereof. The memory/storage devices 1322 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1326 may include interconnection or network interface controllers, components, or other suitable devices to communicate with one or more peripheral devices 1304 or one or more databases 1306 or other network elements via a network 1308. For example, the communication resources 1326 may include wired communication components (e.g., for coupling via USB, Ethernet, etc.), cellular communication components, NFC components, Bluetooth® (or Bluetooth® Low Energy) components, Wi-Fi® components, and other communication components.

Instructions 106, 1318, 1324, 1328, 1332 may comprise software, a program, an application, an applet, an app, or other executable code for causing at least any of the processors 1310 to perform any one or more of the methodologies discussed herein. The instructions 106, 1318, 1324, 1328, 1332 may reside, completely or partially, within at least one of the processors 1310 (e.g., within the processor's cache memory), the memory/storage devices 1322, or any suitable combination thereof. Furthermore, any portion of the instructions 106, 1318, 1324, 1328, 1332 may be transferred to the hardware resources 1330 from any combination of the peripheral devices 1304 or the databases 1306. Accordingly, the memory of processors 1310, the memory/storage devices 1322, the peripheral devices 1304, and the databases 1306 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

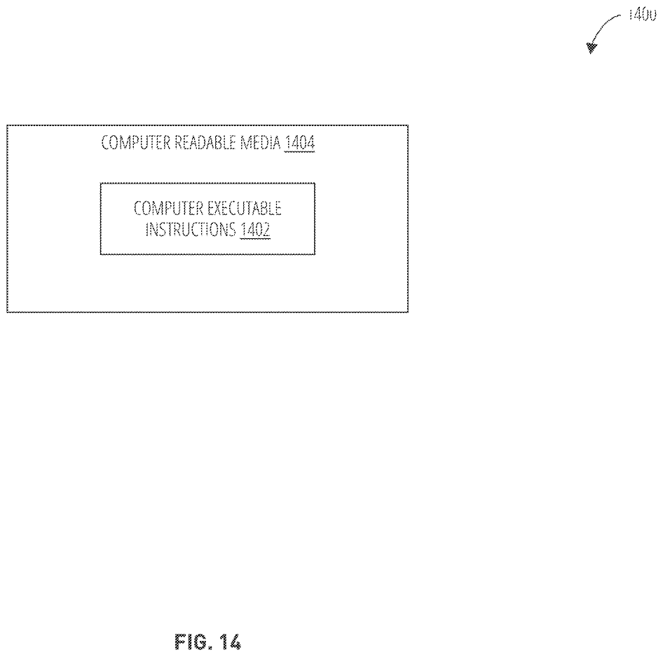

FIG. 14 illustrates computer readable storage medium 1400. Computer readable storage medium 1400 may comprise any non-transitory computer-readable storage medium or machine-readable storage medium, such as an optical, magnetic or semiconductor storage medium. In various embodiments, computer readable storage medium 1400 may comprise an article of manufacture. In some embodiments, computer readable storage medium 1400 may store computer executable instructions 1402 with which circuitry can execute. For example, computer executable instructions 1402 can include computer executable instructions 1402 to implement operations described with respect to logic flow 1100 and/or logic flow 1100. Examples of computer readable storage medium 1400 or machine-readable storage medium 1400 may include any tangible media capable of storing electronic data, including volatile memory or non-volatile memory, removable or non-removable memory, erasable or non-erasable memory, writeable or re-writeable memory, and so forth. Examples of computer executable instructions 1402 may include any suitable type of code, such as source code, compiled code, interpreted code, executable code, static code, dynamic code, object-oriented code, visual code, and the like.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to FIGS. 1-_ may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.

### Example Set 1

Example 1 may include if UE is only equipped with two panels, there are two scenarios according to the relative position of TRPs to the panels: (1) signals from both TRP are in the coverage of two panels, simultaneous reception can work; and (2) due to movement, signals from one of TRP is out of the coverage of one panel, simultaneous reception can't work.
Example 2 may include for RS+data, due to movement, one panel may not receive signal from one TRP. Scheduling restriction will change with time. For some moment, UE is allowed to receive data when data is overlapping with RS. For some moment, UE is not allowed to receive data when data is overlapping with RS.
Example 3 may include for RS+RS case, due to movement, one panel may not receive signal from one TRP. measurement restriction will change with time. For some moment, UE is allowed to receive RS when it is overlapping with another RS. For some moment, UE is not allowed to receive two overlapping RSs.
Example 4 may include for data+data case, when one panel stop working, UE can't continue receiving data from TRP2 by changing beam directions, link recovery can't work either.
Example 5 may consider the scenario that scheduling restriction can't always be applied; applicable condition or threshold needs to be designed to differentiate the different scenarios of scheduling restriction.
Example 6 may consider the scenario that measurement restriction can't always be applied, applicable condition or threshold needs to be designed to differentiate the different scenarios of measurement restriction.
Example 7 may define applicable scenario for simultaneous reception, e.g. two TRPs are in the coverage of two panels.
Example 8 may include if UE are equipped with more than 1 antenna modules and there are two panels in each antenna module, when the signal from one TRP is out of coverage of one panel, UE may activate the panel on the same side of UE to keep simultaneous reception.
Example 9 may include to introduce UE capability to support two antenna modules where there are two panels in each module. Or UE capability to support more than 2 panels.
Example 10 may include a method comprising: identifying that a UE cannot receive a first signal from a first TRP on one or more panels of the UE; and determining a scheduling restriction for simultaneous reception of the first signal from the first TRP and a second signal from a second TRP based on the identification.
Example 11 may include the method of example 10 or some other example herein, wherein one of the first signal or the second signal is a reference signal (RS) and the other of the first signal or the second signal is a data signal, and wherein the scheduling restriction includes receiving the reference signal and not the data signal.
Example 12 may include the method of example 10-11 or some other example herein, wherein the first and second signals are reference signals, and wherein the scheduling restriction includes receiving one of the first or second signals and not receiving the other of the first or second signals.
Example 13 may include a method of a UE, the method comprising: determining that a first antenna panel of the UE cannot receive a signal from a TRP; and activating a second antenna panel of the UE to receive the signal from the TRP based on the determination.
Example 14 may include the method of example 13 or some other example herein, wherein the first antenna panel is included in a first antenna module and the second antenna panel is included in a second antenna module, wherein the second antenna module also includes a third antenna panel.
Example 15 may include the method of example 14 or some other example herein, wherein the signal is a first signal, wherein the TRP is a first TRP, and wherein the method further comprises receiving a second signal from a second TRP on the third antenna panel simultaneously with receiving the first signal from the first TRP on the second antenna panel.

### Example Set 2

Example 1 may include for single TRP scenario, UE can perform simultaneous reception for: (1) Data+RS; (1.a) Data+L1 CSI-RS; (1b) Data+L1 SSB; and (2) RS+RS; (2.a) L1 CSI+L1 SSB.
Example 2 may include UE cannot perform simultaneous reception of SSB+SSB from two intra-cell TRPs.
Example 3 may include intra-cell mTRP, UE can perform simultaneous reception for: (1) Data+RS; (1.a) Data+L1 CSI-RS; (1.b) Data+L1 SSB; (2) RS+RS; (2.a) L1 CSI+L1 CSI-RS; (2.b) L1 CSI+L1 SSB; and (3) Data+Data.
Example 4 may include intra-cell multi-TRP, the scheduling restrictions are as follows: (1) UE is only performing L1 measurement for one TRP; (1.a.) there is scheduling restriction for SSB based measurement if SCS between data and SSB is different and UE doesn't support siimultaneousRxDataSSB-DiffNurmerology; (1.b) there is no scheduling restriction for CSI-RS based measurement; (2) UE is performing L1 measurements for two TRP simultaneously; (2.a) there is scheduling restriction for CSI-RS+CSI-RS or SSB+CSI-RS.
Example 5 may include intra-cell multi-TRP, the measurement restrictions are as follows: (1) there is no measurement restriction for simultaneous reception of CSI-RS+CSI-RS from two TRPs; and (2) there is measurement restriction if SCS between SSB and CSI-RS is different and UE doesn't support simulianeousRxDalaSSB-DiffNumerology.
Example 6 may include a method to be performed by a user equipment (UE), one or more elements of a UE, and/or an electronic device that includes or implements a UE, wherein the method comprises: identifying and processing a first signal from one or more TRPs; and identifying and processing a second signal from the one or more TRPs, wherein the first signal and the second signal are received simultaneously.
Example 7 may include the method of example 6, and/or some other example herein, wherein the first signal is a data signal and the second signal is a reference signal.
Example 8 may include the method of example 6, and/or some other example herein, wherein the first signal is a reference signal and the second signal is a reference signal.
Example 9 may include the method of example 6, and/or some other example herein, wherein the first signal is a data signal and the second signal is a data signal.
Example 10 may include the method of any of examples 6-8, and/or some other example herein, wherein the one or more TRPs are a single TRP.
Example 11 may include the method of any of examples 6-9, and/or some other example herein, wherein the one or more TRPs include an intra-cell mTRP.
Example 12 may include the method of any of examples 6-11, and/or some other example herein, wherein the reference signal is a L1 CSI-RS, an L1 SSB, or an L1 CSI.

### Example Set 3

In one example, an apparatus for a base station, includes a memory interface to send or receive, to or from a data storage device, scheduling information for a wireless communications system. The apparatus also includes processor circuitry communicatively coupled to the memory interface, the processor circuitry to decode a message from user equipment (UE) with UE capability information, the UE capability information to comprise a first information element with a first configuration value to represent antenna information for the UE and a second information element with a second configuration value to represent position and angle information for the UE, determine whether the antenna information and the position and angle information indicates the UE supports simultaneous reception, and generate simultaneous reception information for the UE when the antenna information and the position and angle information indicates the UE supports simultaneous reception, the simultaneous reception information to include scheduling restriction information for the UE.

The apparatus may also include any preceding example and also encoding a message with the simultaneous reception information for the UE.

The apparatus may also include any preceding example and also where the antenna information includes a number of antenna modules and a number of panels for each of the antenna modules for the UE.

The apparatus may also include any preceding example and also where the position and angle information includes a position or an angle of the UE relative to one or more base stations.

The apparatus may also include any preceding example and also where the simultaneous reception information for the UE includes a signal type, a reference signal (RS) type, or a RS measurement type.

The apparatus may also include any preceding example and also where the scheduling restriction information defines a set of conditions for the UE to simultaneously receive or measure multiple signals during simultaneous reception operations by the UE, the multiple signals to comprise multiple data signals, multiple reference signals, or a combination of a data signal and a reference signal.

The apparatus may also include any preceding example and also where the scheduling restriction information represents scheduling availability of the UE performing radio link monitoring on frequency range 1 (FR1) or frequency range 2 (FR2).

The apparatus may also include any preceding example and also where the scheduling restriction information represents scheduling availability of the UE performing beam failure detection on frequency range 1 (FR1) or frequency range 2 (FR2).

The apparatus may also include any preceding example and also where the scheduling restriction information represents scheduling availability of the UE performing TRP specific beam failure detection on frequency range 1 (FR1) or frequency range 2 (FR2).

The apparatus may also include any preceding example and also radio-frequency (RF) circuitry coupled to the processor circuitry, the RF circuitry to transmit a message with the simultaneous reception information for the UE over RF signals. Other technical features may be readily apparent to one skilled in the art from the following figures, descriptions, and claims.

In one example, a method for a base station, includes decoding a message from user equipment (UE) with UE capability information, the UE capability information to comprise a first information element with a first configuration value to represent antenna information for the UE and a second information element with a second configuration value to represent position and angle information for the UE, determining whether the antenna information and the position and angle information indicates the UE supports simultaneous reception, and generating simultaneous reception information for the UE when the antenna information and the position and angle information indicates the UE supports simultaneous reception, the simultaneous reception information to include scheduling restriction information for the UE.

The method may also include any preceding example and also encoding a message with the simultaneous reception information for the UE.

The method may also include any preceding example and also where the antenna information includes a number of antenna modules and a number of panels for each of the antenna modules for the UE.

The method may also include any preceding example and also where the position and angle information includes a position or an angle of the UE relative to one or more base stations.

The method may also include any preceding example and also where the simultaneous reception information for the UE includes a signal type, a reference signal (RS) type, or a RS measurement type.

The method may also include any preceding example and also where the scheduling restriction information defines a set of conditions for the UE to simultaneously receive or measure multiple signals during simultaneous reception operations by the UE, the multiple signals to comprise multiple data signals, multiple reference signals, or a combination of a data signal and a reference signal.

The method may also include any preceding example and also where the scheduling restriction information represents scheduling availability of the UE performing radio link monitoring on frequency range 1 (FR1) or frequency range 2 (FR2).

The method may also include any preceding example and also where the scheduling restriction information represents scheduling availability of the UE performing beam failure detection on frequency range 1 (FR1) or frequency range 2 (FR2).

The method may also include any preceding example and also where the scheduling restriction information represents scheduling availability of the UE performing TRP specific beam failure detection on frequency range 1 (FR1) or frequency range 2 (FR2). Other technical features may be readily apparent to one skilled in the art from the following figures, descriptions, and claims.

In one example, a non-transitory computer-readable storage medium, the computer-readable storage medium including instructions that when executed by a computer, cause the computer to decode a message from user equipment (UE) with UE capability information, the UE capability information to comprise a first information element with a first configuration value to represent antenna information for the UE and a second information element with a second configuration value to represent position and angle information for the UE, determine whether the antenna information and the position and angle information indicates the UE supports simultaneous reception, and generate simultaneous reception information for the UE when the antenna information and the position and angle information indicates the UE supports simultaneous reception, the simultaneous reception information to include scheduling restriction information for the UE.

The computer-readable storage medium may also include any preceding example and also including instructions that when executed by a computer, cause the computer to encode a message with the simultaneous reception information for the UE.

The computer-readable storage medium may also include any preceding example and also where the antenna information includes a number of antenna modules and a number of panels for each of the antenna modules for the UE.

The computer-readable storage medium may also include any preceding example and also where the position and angle information includes a position or an angle of the UE relative to one or more base stations.

The computer-readable storage medium may also include any preceding example and also where the simultaneous reception information for the UE includes a signal type, a reference signal (RS) type, or a RS measurement type.

The computer-readable storage medium may also include any preceding example and also where the scheduling restriction information defines a set of conditions for the UE to simultaneously receive or measure multiple signals during simultaneous reception operations by the UE, the multiple signals to comprise multiple data signals, multiple reference signals, or a combination of a data signal and a reference signal.

The computer-readable storage medium may also include any preceding example and also where the scheduling restriction information represents scheduling availability of the UE performing radio link monitoring on frequency range 1 (FR1) or frequency range 2 (FR2).

The computer-readable storage medium may also include any preceding example and also where the scheduling restriction information represents scheduling availability of the UE performing beam failure detection on frequency range 1 (FR1) or frequency range 2 (FR2).

The computer-readable storage medium may also include any preceding example and also where the scheduling restriction information represents scheduling availability of the UE performing TRP specific beam failure detection on frequency range 1 (FR1) or frequency range 2 (FR2). Other technical features may be readily apparent to one skilled in the art from the following figures, descriptions, and claims.

In one example, an apparatus for a user equipment, includes a memory interface to send or receive, to or from a data storage device, scheduling information for a wireless communications system. The apparatus also includes processor circuitry communicatively coupled to the memory interface, the processor circuitry to encode a first message for a base station with UE capability information, the UE capability information to comprise a first information element with a first configuration value to represent antenna information for the UE and a second information element with a second configuration value to represent position and angle information for the UE, decode a second message from the base station with UE configuration information, the UE configuration information to comprise a first information element with a first configuration value to represent simultaneous reception information for the UE, the simultaneous reception information to include scheduling restriction information for the UE, and determine whether the simultaneous reception information and the scheduling restriction information indicates the UE can support simultaneous reception of signals from one or more transmission and reception points (TRPs).

The apparatus may also include any preceding example and also the processor circuitry to cause the UE to perform simultaneous reception of signals from the one or more TRPs in accordance with the scheduling restriction information when the UE can support simultaneous reception.

The apparatus may also include any preceding example and also the processor circuitry to encode a third message for the base station with updated UE capability information, the updated UE capability information to comprise a third information element with a third configuration value to represent updated position and angle information for the UE.

The apparatus may also include any preceding example and also the processor circuitry to decode a fourth message from the base station with updated UE configuration information, the updated UE configuration information to comprise a third information element with a third configuration value to represent updated simultaneous reception information for the UE, the updated simultaneous reception information to include updated scheduling restriction information for the UE.

The apparatus may also include any preceding example and also where the first message includes a second information element with a second configuration value to represent UE capability information, the second configuration value to represent TRP information for the TRPs detected by the UE or measurement information to represent measurement capabilities for the UE.

The apparatus may also include any preceding example and also where the second message includes a second information element with a second configuration value to represent simultaneous reception information for the UE, the second configuration value to comprise a signal type, a reference signal type, or a reference signal measurement type.

The apparatus may also include any preceding example and also where the scheduling restriction information defines a set of conditions for the UE to simultaneously receive or measure multiple signals during simultaneous reception operations by the UE, the multiple signals to comprise multiple data signals, multiple reference signals, or a combination of a data signal and a reference signal.

The apparatus may also include any preceding example and also where the scheduling restriction information represents scheduling availability of the UE performing radio link monitoring on frequency range 1 (FR1) or frequency range 2 (FR2).

The apparatus may also include any preceding example and also where the scheduling restriction information represents scheduling availability of the UE performing beam failure detection on frequency range 1 (FR1) or frequency range 2 (FR2).

The apparatus may also include any preceding example and also where the scheduling restriction information represents scheduling availability of the UE performing TRP specific beam failure detection on frequency range 1 (FR1) or frequency range 2 (FR2).

The apparatus may also include any preceding example and also radio-frequency (RF) circuitry coupled to the processor circuitry, the RF circuitry to transmit the first message with the UE capability information over RF signals to the base station, and receive the second message with the simultaneous reception information for the UE over RF signals from the base station. Other technical features may be readily apparent to one skilled in the art from the following figures, descriptions, and claims.

In one example, a method for a user equipment, includes encoding a first message for a base station with UE capability information, the UE capability information to comprise a first information element with a first configuration value to represent antenna information for the UE and a second information element with a second configuration value to represent position and angle information for the UE, decoding a second message from the base station with UE configuration information, the UE configuration information to comprise a first information element with a first configuration value to represent simultaneous reception information for the UE, the simultaneous reception information to include scheduling restriction information for the UE, and determining whether the simultaneous reception information and the scheduling restriction information indicates the UE can support simultaneous reception of signals from one or more transmission and reception points (TRPs).

The method may also include any preceding example and also performing simultaneous reception of signals from the one or more TRPs in accordance with the scheduling restriction information when the UE can support simultaneous reception.

The method may also include any preceding example and also encoding a third message for the base station with updated UE capability information, the updated UE capability information to comprise a third information element with a third configuration value to represent updated position and angle information for the UE.

The method may also include any preceding example and also decoding a fourth message from the base station with updated UE configuration information, the updated UE configuration information to comprise a third information element with a third configuration value to represent updated simultaneous reception information for the UE, the updated simultaneous reception information to include updated scheduling restriction information for the UE.

The method may also include any preceding example and also where the first message includes a second information element with a second configuration value to represent UE capability information, the second configuration value to represent TRP information for the TRPs detected by the UE or measurement information to represent measurement capabilities for the UE.

The method may also include any preceding example and also where the second message includes a second information element with a second configuration value to represent simultaneous reception information for the UE, the second configuration value to comprise a signal type, a reference signal type, or a reference signal measurement type.

The method may also include any preceding example and also where the scheduling restriction information defines a set of conditions for the UE to simultaneously receive or measure multiple signals during simultaneous reception operations by the UE, the multiple signals to comprise multiple data signals, multiple reference signals, or a combination of a data signal and a reference signal.

The method may also include any preceding example and also where the scheduling restriction information represents scheduling availability of the UE performing beam failure detection on frequency range 1 (FR1) or frequency range 2 (FR2).

The method may also include any preceding example and also where the scheduling restriction information represents scheduling availability of the UE performing TRP specific beam failure detection on frequency range 1 (FR1) or frequency range 2 (FR2). Other technical features may be readily apparent to one skilled in the art from the following figures, descriptions, and claims.

In one example, a non-transitory computer-readable storage medium, the computer-readable storage medium including instructions that when executed by a computer, cause the computer to encode a first message for a base station with UE capability information, the UE capability information to comprise a first information element with a first configuration value to represent antenna information for the UE and a second information element with a second configuration value to represent position and angle information for the UE, decode a second message from the base station with UE configuration information, the UE configuration information to comprise a first information element with a first configuration value to represent simultaneous reception information for the UE, the simultaneous reception information to include scheduling restriction information for the UE, and determine whether the simultaneous reception information and the scheduling restriction information indicates the UE can support simultaneous reception of signals from one or more transmission and reception points (TRPs).

The computer-readable storage medium may also include any preceding example and also instructions that when executed by a computer, cause the computer to perform simultaneous reception of signals from the one or more TRPs in accordance with the scheduling restriction information when the UE can support simultaneous reception.

The computer-readable storage medium may also include any preceding example and also instructions that when executed by a computer, cause the computer to encode a third message for the base station with updated UE capability information, the updated UE capability information to comprise a third information element with a third configuration value to represent updated position and angle information for the UE.

The computer-readable storage medium may also include any preceding example and also instructions that when executed by a computer, cause the computer to decode a fourth message from the base station with updated UE configuration information, the updated UE configuration information to comprise a third information element with a third configuration value to represent updated simultaneous reception information for the UE, the updated simultaneous reception information to include updated scheduling restriction information for the UE.

The computer-readable storage medium may also include any preceding example and also where the first message includes a second information element with a second configuration value to represent UE capability information, the second configuration value to represent TRP information for the TRPs detected by the UE or measurement information to represent measurement capabilities for the UE.

The computer-readable storage medium may also include any preceding example and also where the second message includes a second information element with a second configuration value to represent simultaneous reception information for the UE, the second configuration value to comprise a signal type, a reference signal type, or a reference signal measurement type.

The computer-readable storage medium may also include any preceding example and also where the scheduling restriction information defines a set of conditions for the UE to simultaneously receive or measure multiple signals during simultaneous reception operations by the UE, the multiple signals to comprise multiple data signals, multiple reference signals, or a combination of a data signal and a reference signal.

The computer-readable storage medium may also include any preceding example and also where the scheduling restriction information represents scheduling availability of the UE performing radio link monitoring on frequency range 1 (FR1) or frequency range 2 (FR2).

The computer-readable storage medium may also include any preceding example and also where the scheduling restriction information represents scheduling availability of the UE performing beam failure detection on frequency range 1 (FR1) or frequency range 2 (FR2).

The computer-readable storage medium may also include any preceding example and also where the scheduling restriction information represents scheduling availability of the UE performing TRP specific beam failure detection on frequency range 1 (FR1) or frequency range 2 (FR2). Other technical features may be readily apparent to one skilled in the art from the following figures, descriptions, and claims.

In one example, an apparatus for a base station, includes means for decoding a message from user equipment (UE) with UE capability information, the UE capability information to comprise a first information element with a first configuration value to represent antenna information for the UE and a second information element with a second configuration value to represent position and angle information for the UE, means for determining whether the antenna information and the position and angle information indicates the UE supports simultaneous reception, and means for generating simultaneous reception information for the UE when the antenna information and the position and angle information indicates the UE supports simultaneous reception, the simultaneous reception information to include scheduling restriction information for the UE.

The apparatus may also include any preceding example and also means for encoding a message with the simultaneous reception information for the UE.

The apparatus may also include any preceding example and also where the antenna information includes a number of antenna modules and a number of panels for each of the antenna modules for the UE.

The apparatus may also include any preceding example and also where the position and angle information includes a position or an angle of the UE relative to one or more base stations.

The apparatus may also include any preceding example and also where the simultaneous reception information for the UE includes a signal type, a reference signal (RS) type, or a RS measurement type.

The apparatus may also include any preceding example and also where the scheduling restriction information defines a set of conditions for the UE to simultaneously receive or measure multiple signals during simultaneous reception operations by the UE, the multiple signals to comprise multiple data signals, multiple reference signals, or a combination of a data signal and a reference signal.

The apparatus may also include any preceding example and also where the scheduling restriction information represents scheduling availability of the UE performing radio link monitoring on frequency range 1 (FR1) or frequency range 2 (FR2).

The apparatus may also include any preceding example and also where the scheduling restriction information represents scheduling availability of the UE performing beam failure detection on frequency range 1 (FR1) or frequency range 2 (FR2).

The apparatus may also include any preceding example and also where the scheduling restriction information represents scheduling availability of the UE performing TRP specific beam failure detection on frequency range 1 (FR1) or frequency range 2 (FR2).

The apparatus may also include any preceding example and also means for transmitting a message with the simultaneous reception information for the UE over radio-frequency (RF) signals. Other technical features may be readily apparent to one skilled in the art from the following figures, descriptions, and claims.

In one example, an apparatus for a user equipment, includes means for encoding a first message for a base station with UE capability information, the UE capability information to comprise a first information element with a first configuration value to represent antenna information for the UE and a second information element with a second configuration value to represent position and angle information for the UE, means for decoding a second message from the base station with UE configuration information, the UE configuration information to comprise a first information element with a first configuration value to represent simultaneous reception information for the UE, the simultaneous reception information to include scheduling restriction information for the UE, and means for determining whether the simultaneous reception information and the scheduling restriction information indicates the UE can support simultaneous reception of signals from one or more transmission and reception points (TRPs).

The apparatus may also include any preceding example and also means for performing simultaneous reception of signals from the one or more TRPs in accordance with the scheduling restriction information when the UE can support simultaneous reception.

The apparatus may also include any preceding example and also means for encoding a third message for the base station with updated UE capability information, the updated UE capability information to comprise a third information element with a third configuration value to represent updated position and angle information for the UE.

The apparatus may also include any preceding example and also means for decoding a fourth message from the base station with updated UE configuration information, the updated UE configuration information to comprise a third information element with a third configuration value to represent updated simultaneous reception information for the UE, the updated simultaneous reception information to include updated scheduling restriction information for the UE.

The apparatus may also include any preceding example and also where the first message includes a second information element with a second configuration value to represent UE capability information, the second configuration value to represent TRP information for the TRPs detected by the UE or measurement information to represent measurement capabilities for the UE.

The apparatus may also include any preceding example and also where the second message includes a second information element with a second configuration value to represent simultaneous reception information for the UE, the second configuration value to comprise a signal type, a reference signal type, or a reference signal measurement type.

The apparatus may also include any preceding example and also where the scheduling restriction information defines a set of conditions for the UE to simultaneously receive or measure multiple signals during simultaneous reception operations by the UE, the multiple signals to comprise multiple data signals, multiple reference signals, or a combination of a data signal and a reference signal.

The apparatus may also include any preceding example and also where the scheduling restriction information represents scheduling availability of the UE performing radio link monitoring on frequency range 1 (FR1) or frequency range 2 (FR2).

The apparatus may also include any preceding example and also where the scheduling restriction information represents scheduling availability of the UE performing beam failure detection on frequency range 1 (FR1) or frequency range 2 (FR2).

The apparatus may also include any preceding example and also where the scheduling restriction information represents scheduling availability of the UE performing TRP specific beam failure detection on frequency range 1 (FR1) or frequency range 2 (FR2).

The apparatus may also include any preceding example and also means for transmitting the first message with the UE capability information over RF signals to the base station, and receiving the second message with the simultaneous reception information for the UE over RF signals from the base station. Other technical features may be readily apparent to one skilled in the art from the following figures, descriptions, and claims.

The method may also include any preceding example and also7, where the scheduling restriction information represents scheduling availability of the UE performing radio link monitoring on frequency range 1 (FR1) or frequency range 2 (FR2). Other technical features may be readily apparent to one skilled in the art from the following figures, descriptions, and claims.

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to providing a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1-25. (canceled)

26. An apparatus for a base station, comprising:
a memory interface to send or receive, to or from a data storage device, scheduling information for a wireless communications system; and
processor circuitry communicatively coupled to the memory interface, the processor circuitry to:
decode a message from user equipment (UE) with UE capability information, the UE capability information to comprise a first information element with a first configuration value to represent antenna information for the UE and a second information element with a second configuration value to represent position and angle information for the UE;
determine whether the antenna information and the position and angle information indicates the UE supports simultaneous reception; and
generate simultaneous reception information for the UE when the antenna information and the position and angle information indicates the UE supports simultaneous reception, the simultaneous reception information to include scheduling restriction information for the UE.

27. The apparatus of claim 26, comprising encoding a message with the simultaneous reception information for the UE.

28. The apparatus of claim 26, wherein the antenna information comprises a number of antenna modules and a number of panels for each of the antenna modules for the UE.

29. The apparatus of claim 26, wherein the position and angle information comprises a position or an angle of the UE relative to one or more base stations.

30. The apparatus of claim 26, wherein the simultaneous reception information for the UE comprises a signal type, a reference signal (RS) type, or a RS measurement type.

31. The apparatus of claim 26, wherein the scheduling restriction information defines a set of conditions for the UE to simultaneously receive or measure multiple signals during simultaneous reception operations by the UE, the multiple signals to comprise multiple data signals, multiple reference signals, or a combination of a data signal and a reference signal.

32. The apparatus of claim 26, wherein the scheduling restriction information represents scheduling availability of the UE performing radio link monitoring on frequency range 1 (FR1) or frequency range 2 (FR2).

33. The apparatus of claim 26, wherein the scheduling restriction information represents scheduling availability of the UE performing beam failure detection on frequency range 1 (FR1) or frequency range 2 (FR2).

34. The apparatus of claim 26, wherein the scheduling restriction information represents scheduling availability of the UE performing TRP specific beam failure detection on frequency range 1 (FR1) or frequency range 2 (FR2).

35. A method for a base station, comprising:
decoding a message from user equipment (UE) with UE capability information, the UE capability information to comprise a first information element with a first configuration value to represent antenna information for the UE and a second information element with a second configuration value to represent position and angle information for the UE;
determining whether the antenna information and the position and angle information indicates the UE supports simultaneous reception; and
generating simultaneous reception information for the UE when the antenna information and the position and angle information indicates the UE supports simultaneous reception, the simultaneous reception information to include scheduling restriction information for the UE.

36. The method of claim 35, comprising encoding a message with the simultaneous reception information for the UE.

37. The method of claim 35, wherein the antenna information comprises a number of antenna modules and a number of panels for each of the antenna modules for the UE.

38. The method of claim 35, wherein the position and angle information comprises a position or an angle of the UE relative to one or more base stations.

39. The method of claim 35, wherein the simultaneous reception information for the UE comprises a signal type, a reference signal (RS) type, or a RS measurement type.

40. The method of claim 35, wherein the scheduling restriction information defines a set of conditions for the UE to simultaneously receive or measure multiple signals during simultaneous reception operations by the UE, the multiple signals to comprise multiple data signals, multiple reference signals, or a combination of a data signal and a reference signal.

41. A non-transitory computer-readable storage medium, the computer-readable storage medium including instructions that when executed by a computer, cause the computer to:
decode a message from user equipment (UE) with UE capability information, the UE capability information to comprise a first information element with a first configuration value to represent antenna information for the UE and a second information element with a second configuration value to represent position and angle information for the UE;
determine whether the antenna information and the position and angle information indicates the UE supports simultaneous reception; and
generate simultaneous reception information for the UE when the antenna information and the position and angle information indicates the UE supports simultaneous reception, the simultaneous reception information to include scheduling restriction information for the UE.

42. The computer-readable storage medium of claim 41, comprising including instructions that when executed by a computer, cause the computer to encode a message with the simultaneous reception information for the UE.

43. The computer-readable storage medium of claim 41, wherein the scheduling restriction information defines a set of conditions for the UE to simultaneously receive or measure multiple signals during simultaneous reception operations by the UE, the multiple signals to comprise multiple data signals, multiple reference signals, or a combination of a data signal and a reference signal.

44. The computer-readable storage medium of claim 41, wherein the scheduling restriction information represents scheduling availability of the UE performing radio link monitoring on frequency range 1 (FR1) or frequency range 2 (FR2).

45. The computer-readable storage medium of claim 41, wherein the scheduling restriction information represents scheduling availability of the UE performing beam failure detection on frequency range 1 (FR1) or frequency range 2 (FR2).
